(19) United States
(12) Patent Application Publication
(10) Pub. No.: US 2015/0095537 A1
(43) Pub. Date: Apr. 2, 2015

(54) CAMERA CONTROL INTERFACE SLEEP AND WAKE UP SIGNALING

(71) Applicant: QUALCOMM Incorporated, San Diego, CA (US)

(72) Inventor: Shoichiro Sengoku, San Diego, CA (US)

(21) Appl. No.: 14/504,413

(22) Filed: Oct. 1, 2014

Related U.S. Application Data
(60) Provisional application No. 61/885,995, filed on Oct. 2, 2013.

(51) Int. Cl. G06F 13/362; G06F 1/32

(52) U.S. Cl. CPC G06F 13/362; G06F 1/3253
USPC 710/110

(57) ABSTRACT

A device is provided comprising a control data bus including at least a first line. A master device may be coupled to the control data bus and configured to control the control data bus. A plurality of slave devices may be coupled to the control data bus and share the first line. The master device may be configured to send a single global wake up signal on the control data bus that causes any sleeping slave devices to wake up. Alternatively, the master device may send a global wake up signal followed by a targeted sleep signal to non-targeted slave devices to implement a “targeted wake up” of specific slave devices. The master device may send the single global wake up signal by bringing the first line low for a predetermined period of time.

### CROSS-REFERENCE TO RELATED APPLICATIONS

The present Application for Patent claims priority to Provisional Application No. App. No. 61/885,995, entitled “Camera Control Interface Sleep and Wakeup Signaling” filed Oct. 2, 2013, which is assigned to the assignee hereof and hereby expressly incorporated by reference herein.

### FIELD

The present disclosure pertains to enabling operations over a shared control data bus and, more particularly, to transmitting sleep and wake up signals over a multi-wire data and/or clock control data bus.

### BACKGROUND

I2C (also referred to as I²C) is a multi-master serial single-ended control data bus used for attaching low-speed peripherals to a motherboard, embedded system, cellphone, or other electronic devices. The I2C control data bus includes a clock (SCL) and data (SDA) lines with 7-bit addressing. The control data bus has two roles for nodes: master and slave. A master node is a node that generates the clock and initiates communication with slave nodes. A slave node is a node that receives the clock and responds when addressed by the master. The I2C control data bus is a multi-master control data bus which means any number of master nodes can be present. Additionally, master and slave roles may be changed between messages. I2C defines basic types of messages, each of which begins with a START and ends with a STOP.

In this context of a camera implementation, unidirectional transmissions may be used to capture an image from a sensor and transmit such image data to memory in a baseband processor, while control data may be exchanged between the baseband processor and the sensor as well as other peripheral devices. In one example, a Camera Control Interface (CCI) protocol may be used for such control data between the baseband processor and the image sensor (and/or one or more slave nodes). In one example, the CCI protocol may be implemented over an I2C serial control data bus between the image sensor and the baseband processor.

In the I2C control data bus system, when an I2C slave device has sleep functionality to put the device into a low power consumption mode without shutting down the power so that it can resume operation in a swift manner, at least one side band signal is necessary from the host/master device to indicate a “wake up” event. For example, when there are 10 slave devices with such functionality, then the system must have 10 “wake up” signals, costing pins of devices especially for the host/master device, and extra wires on the circuit board. In other words, currently there exists a pin and an associated circuit board wire needed to wake up individually each single slave device in the sleep mode.

Therefore, it is desirable to reduce the number of pins and/or wires utilized in waking up slave devices in the sleep mode and/or instructing active slave devices to enter the sleep mode.

### SUMMARY

A first feature provides a device comprising a control data bus including at least a first line. A master device may be coupled to the control data bus and configured to control the control data bus. A plurality of slave devices may be coupled to the control data bus and sharing the first line, wherein the master device is configured to send a single global wake up signal on the control data bus that causes any sleeping slave devices to wake up.

A second feature provides a method operational on a master device. The master device may control transmissions over a control data bus, the control data bus including at least a first line. The master device may transmit, via the control data bus from the master device to a plurality of slave devices, a single global wake up signal that causes any sleeping slave devices to wake up. The master device may maintain a slave device sleep status list. The control data bus may be a two-line bus and the wake up signal may be implemented by bringing the first line high or low for a predetermined period of time.

According to one aspect, the master device may receive an interrupt signal after each slave device wakes up. This allows the master device to update the slave device sleep status list based on the received interrupt signal.

In one example, the master device may be dynamically configurable to operate in either a master mode or slave mode, and when the master device receives a master request from a first slave device, the master device transfers the slave device sleep status list of sleeping slave devices to the first slave device before transferring control of the control data bus to the first slave device. The master device may then switch to operate in slave mode after transferring control of the control data bus.

In another example, the master device may send a sleep broadcast signal to all devices coupled to the control data bus, wherein the sleep broadcast signal specifically identifies one or more slave devices that should go into the sleep mode or specifically identifies one or more slave devices that should ignore the sleep request.

The master device may also receive an interrupt signal, via an interrupt request bus, from a first slave device indicating that the first slave device is entering into the sleep mode. Upon receipt of such interrupt signal, the master device may add the first slave device to a slave device sleep status list.

The master device may also receive an interrupt signal from a slave device, via an interrupt request bus separate from the control data bus, indicating that the slave device has spontaneously woken up. Upon receipt of the interrupt signal, the master device may remove the first slave device from a slave device sleep status list.

If the master device enters into a sleep mode, and the master device may be adapted to wake up upon receipt of a first interrupt signal from a slave device over an interrupt line separate from control data bus. The master device may make use of an arbitration protocol used by the slave devices to arbitrate between contenting slave devices that issue concurrent and/or overlapping interrupt signals over the interrupt line or bus. That is, slave devices may assert their interrupt signals by pulling down (e.g., to ground) the interrupt line for a first predetermined amount of time (or a first time range). The master device, upon wakening up using the detected interrupt signal, holds the interrupt line low for a second period of time, where the second period of time is longer than the first period of time. This causes any slave device that is currently or contemporaneously asserting an interrupt signal to recognize that there is contention on the interrupt line (e.g., the interrupt line stays low even when the interrupt signal from the slave device ends). Consequently, the arbitration protocol/mechanism may indicate that the slave device resend its interrupt signal after it senses that the interrupt line has gone high again. Therefore, no changes are needed at the slave device to implement master device sleep mode since the master device wake up mechanism makes use of the existing interrupt arbitration mechanism.

While the master device is awake (e.g., not in a sleep mode), if it receive an interrupt signal from a first slave device. As a result of receiving such interrupt signal, the master device removes that first slave device from a slave device sleep status list. That is, receipt of an interrupt signal from a particular slave device acts as an indication that such slave device is not in a sleep mode and, if present in the slave device sleep status list, it is removed from such list.

A third feature provides a master device comprising a bus interface to couple to a control data bus shared with a plurality of slave devices; and a processing circuit coupled to the bus interface. The processing circuit may be configured to: (a) manage access to the control data bus by the plurality of slave devices (e.g., manage which device can use the control data bus), and/or (b) issue a global wake up command to the plurality of slave devices over the control data bus. The master device may also implement a multi-step targeted wake up mechanism to wake up a targeted slave device(s) by sending a global wake up signal over the control data bus (which wakes up all slave devices) followed by a targeted sleep signal to non-targeted slave devices (which instructs the non-targeted devices to go to sleep). The master device may send the single global wake up signal by bringing the first line low for a predetermined period of time. Additionally, the master device may operate in a normal/awake mode to control access/communications over the control data bus but may also go into a sleep mode. In order to wake up from the sleep mode, the master device may rely on interrupt signals from slave devices and relies on the interrupt arbitration protocol to have slave devices resend interrupt signals when no response is received from the master device.

A fourth feature provides a slave device comprising a bus interface to couple to a control data bus shared with a plurality of slave devices, and a receiver logic circuit coupled to the bus interface. When the slave device is in a sleep mode of operation, the receiver circuit may be configured to: (a) obtain a free running clock signal, (b) use the free running clock signal to measure a length of time a line of the control data bus is either pulled low or high, and/or (c) wake up the slave device if the measured length of time is greater than a predetermined amount of time.

### BRIEF DESCRIPTION OF THE DRAWINGS

Various features, nature, and advantages may become apparent from the detailed description set forth below when taken in conjunction with the drawings in which like reference characters identify correspondingly throughout.

FIG. 1 is a block diagram illustrating an exemplary device having a baseband processor and an image sensor and implementing an image data bus and a multi-mode control data bus.

FIG. 2 conceptually illustrates an exemplary write data word.

FIG. 3 is a conceptual illustration of an exemplary message frame or general call.

FIG. 4 conceptually illustrates an exemplary first step of a master device initiated sleep process.

FIG. 5 conceptually illustrates two exemplary sleep commands.

FIG. 6 illustrates an exemplary second step of the master device initiated sleep process.

FIG. 7 illustrates an exemplary first step of a slave device initiated sleep process.

FIG. 8 illustrates an exemplary second step of the slave device initiated sleep process.

FIG. 9 conceptually and graphically illustrates how a master device may send a sleep command targeting a specific slave device.

FIG. 10 conceptually and graphically illustrates how a targeted slave device enters a sleep mode in response to a targeted sleep command from a master device.

FIG. 11 conceptually illustrates that a master device may maintain a slave device sleep status list.

FIG. 12 illustrates an exemplary master device handoff protocol.

FIG. 13 illustrates an exemplary first step of a master device initiated wake up protocol.

FIG. 14 illustrates an exemplary second step of a master device initiated wake up protocol.

FIG. 15 illustrates an exemplary third step of the master device initiated wake up protocol.

FIG. 16 illustrates an exemplary fourth step of the master device initiated wake up protocol.

FIG. 17 illustrates exemplary slave device receiver logic to receive a master device initiated wake up signal.

FIG. 18 is a block diagram illustrating an exemplary method for transcoding of data bits into transcoded symbols.

FIG. 19 illustrates an example of a 20-bit region comprising a 19 bit data region (e.g., bits 0-18) and an additional 20^{th} bit region (e.g., bit 19).

FIG. 20 illustrates that besides the bit 19 being set for numbers 2221_{—}2201_{—}2202₃ to 2222_{—}2222_{—}2222₃, that range of numbers can be subdivided into six sections.

FIG. 21 illustrates an exemplary slave device logic that generates a reset signal upon sensing a master device initiated wake up.

FIG. 22 illustrates a scenario in which a trigger external to a master device is triggering interaction with a sleeping slave device.

FIG. 23 illustrates a first approach of how a slave device may spontaneously wake up and notify the master device that it has woken up by issuing an interrupt request (IRQ).

FIG. 24 illustrates a second approach of how a slave device may spontaneously wake up and notify the master device that it has woken up by issuing an interrupt request (IRQ).

FIG. 25 illustrates an implementation where a slave device initiates wake up of a sleeping master device.

FIG. 26 illustrates an exemplary master device receiver logic that generates a wake up signal in response to interrupt request from slave device.

FIG. 27 is a block diagram illustrating an exemplary master device adapted for monitoring and controlling sleep modes of slave devices a shared bus controlled by the master device.

FIG. 28 illustrates an exemplary method operational at a master device to awaken from a sleep mode and/or to awake one or more sleeping slave devices.

FIG. 29 illustrates an exemplary method operational at a master device for maintaining the sleep and/or awake status of slave devices.

FIG. 30 is a block diagram illustrating an exemplary slave device adapted for master device-controlled wake up/sleep and spontaneous wake up on a shared bus controlled by the master device.

FIG. 31 illustrates an exemplary method operational at a slave device for maintaining the sleep and/or awake status of slave devices.

### DETAILED DESCRIPTION

In the following description, specific details are given to provide a thorough understanding of the embodiments. However, it will be understood by one of ordinary skill in the art that the embodiments may be practiced without these specific detail. For example, circuits may be shown in block diagrams in order not to obscure the embodiments in unnecessary detail. In other instances, well-known circuits, structures, and techniques may not be shown in detail in order not to obscure the embodiments.

### Overview

A first feature provides transmitting on a system data line (SDA), by a master device to a plurality of slave devices, at least one of a sleep only command identifying exactly which slave devices go to sleep and a sleep except command identifying exactly which slave devices stay awake. The two sleep commands may be issued in an extended CCI (CCIe) write data format. For both commands, the list being positively recited is specified in a slave device identification (SID) list. For example, the sleep only command is followed by a SID list that lists the slave devices by their respective identifier (ID) that are to go to sleep. Similarly, the sleep except command is followed by a SID list that lists the slave devices by ID that are to stay awake. Additionally, a global wake up command is available that wakes up all sleeping slave devices. While the sleep commands and the global wake up command are transmitted on the SDA, information from the slave devices can be communicated to the master device via an interrupt line (IRQ or IRQN). For example, the woken up slave devices can send a confirmation of being fully awake to the master device via the IRQ line.

A second feature provides for placing a plurality of slave devices into groups on a shared interrupt request line, wherein some of the slave devices have a spontaneous wake up feature, and some of the slave devices do not have the spontaneous wake up feature. All slave devices that have the spontaneous wake up feature may be placed in a group of size one (i.e., one slave device per group). This eliminates a need to wake up all slave devices to investigate which formally asleep slave device is now awake.

A third feature provides for a master device to enter into a sleep mode and uses a receiver logic to wake up upon detection of an interrupt signal from a slave device over the interrupt request line. The master device may make use of an arbitration protocol used by the slave devices to arbitrate between contenting slave devices that issue concurrent and/or overlapping interrupt signals over the interrupt line or bus. That is, slave devices may assert their interrupt signals by pulling down (e.g., to ground) the interrupt line for a first predetermined amount of time (or a first time range). The master device, upon wakening up using the detected interrupt signal, holds the interrupt line low for a second period of time, where the second period of time is longer than the first period of time. This serve to indicate signal contention on the interrupt bus to the slave devices which then follow an arbitration protocol which resends their interrupt when the interrupt line goes high.

### Exemplary Method for Sending Sleep and Wake Up Signals on an I2C Control Data Bus

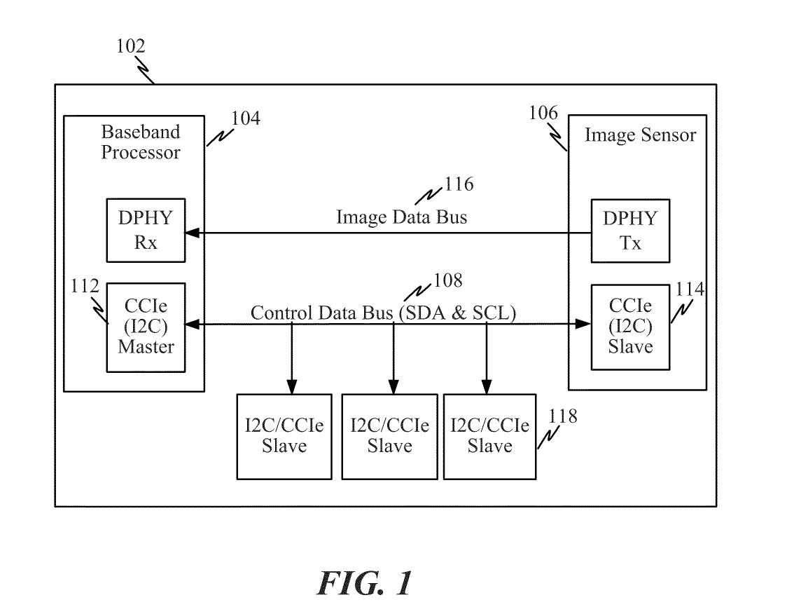

FIG. 1 is a block diagram illustrating an exemplary device 102 having a baseband processor 104 and an image sensor 106 and implementing an image data bus 116 and a multi-mode control data bus 108. While FIG. 1 illustrates the multi-mode control data bus 108 within a camera device, it should be clear that this control data bus 108 may be implemented in various different devices and/or systems. Image data may be sent from the image sensor 106 to the baseband processor 104 over an image data bus 116 (e.g., a high speed differential DPHY link). In one example, the control data bus 108 may be an I2C control data bus comprising two wires, a clock line (SCL) and a serial data line (SDA). The clock line SCL may be used to synchronize all data transfers over the I2C bus (control data bus 108). The data line SDA and clock line SCL are coupled to all devices 112, 114, and 118 on the I2C bus (control data bus 108). In this example, control data may be exchanged between the baseband processor 104 and the image sensor 106 as well as other peripheral devices 118 (e.g., slave devices) via the control data bus 108. In some implementations, the operating modes over an I2C control data bus may be referred to as a camera control interface (CCI) mode when used for camera applications.

According to one aspect, an improved mode of operation may be implemented over the multi-mode control data bus 108 to support camera operation. This improved mode of operation over an I2C control data bus may be referred to as a camera control interface extension (CCIe) mode when used for camera applications. In this example, the baseband processor 104 includes a master node 112 and the image sensor 106 includes a slave node 114, both the master node 112 and slave node 114 may operate according to the camera control interface extension (CCIe) mode over the control data bus 108 without affecting the proper operation of other legacy I2C devices (e.g., devices that do not operate in CCIe mode) coupled to the control data bus 108. According to one aspect, this improved mode over the control data bus 108 may be implemented without any bridge device between CCIe devices and any legacy I2C slave devices.

According to one aspect, all slave devices 118 may be CCIe-capable devices with the ability to enter a sleep mode that utilizes less energy than an awake mode (i.e., normal mode). The sleep mode allows the slave devices 118 to switch to the normal mode sooner or more quickly than if the slave devices were turned off instead. For example, CCIe devices typically have a 32.768 kHz real-time clock and/or other slow clocks that still run during sleep mode, a “wake up” indication by the master device to the slave device can be achieved with a receiver logic circuit and with the master device holding/pulling the SDA line down/low for a long period (e.g., 40 μseconds). The period for which the SDA line is held/pulled down/low may be sufficiently long that no other device coupled to the shared control data bus 108 confuses it for another CCIe or I2C operation or signal (e.g., such other CCIe or I2C operations over the control data bus 108 hold the line low for a shorter period). Consequently, all other CCIe or I2C operations or signals will never be detected as a “wake up” indication. Since this method will wake up not only the intended slave device but all the slave devices with the function on the same control data bus, the host/master device then issue a “sleep” command action to each device that should be in sleep mode. The herein describes methods and apparatus avoids the use of extra side band signals for “wake up” indication, therefore reduces device pin counts as well as number of wires on the circuit board.

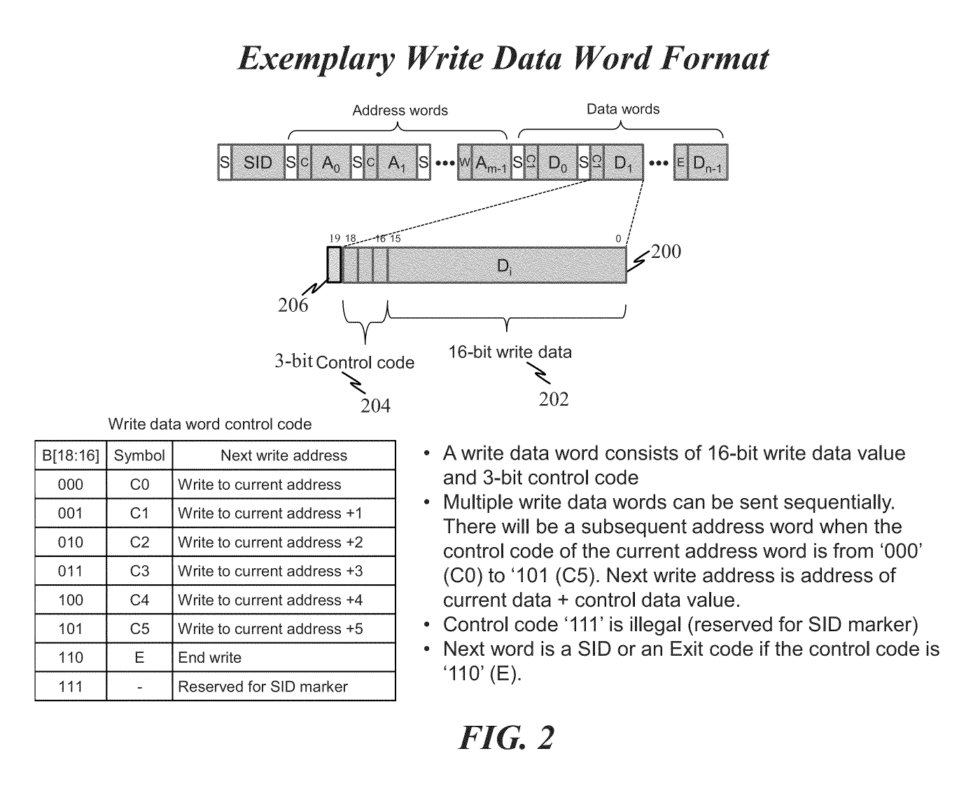

FIG. 2 conceptually illustrates an exemplary write data word 200 where 16 bits, (bits 0 to 15) 202 are write data and 3 bits are control code bits (bits 16 to 18) 204. That is, a write data word may consist of, or include, a 16-bit write data value and 3-bit control code bits. In one example, the write data word 200 may be a CCIe write data word. There will be a subsequent address word when the control code of the current address word is from ‘000’ (C0) to ‘101’ (C5). The next write address is the address of current data plus a control data value. A control code of ‘111’ is illegal because it is reserved for a SID marker. Next word is a SID (slave device ID) or an Exit code if the control code is ‘110’ (E). The data word 200 can have a spare bit 206 (e.g., bit 19) that may be used to transmit commands and other information between the master device and slave devices.

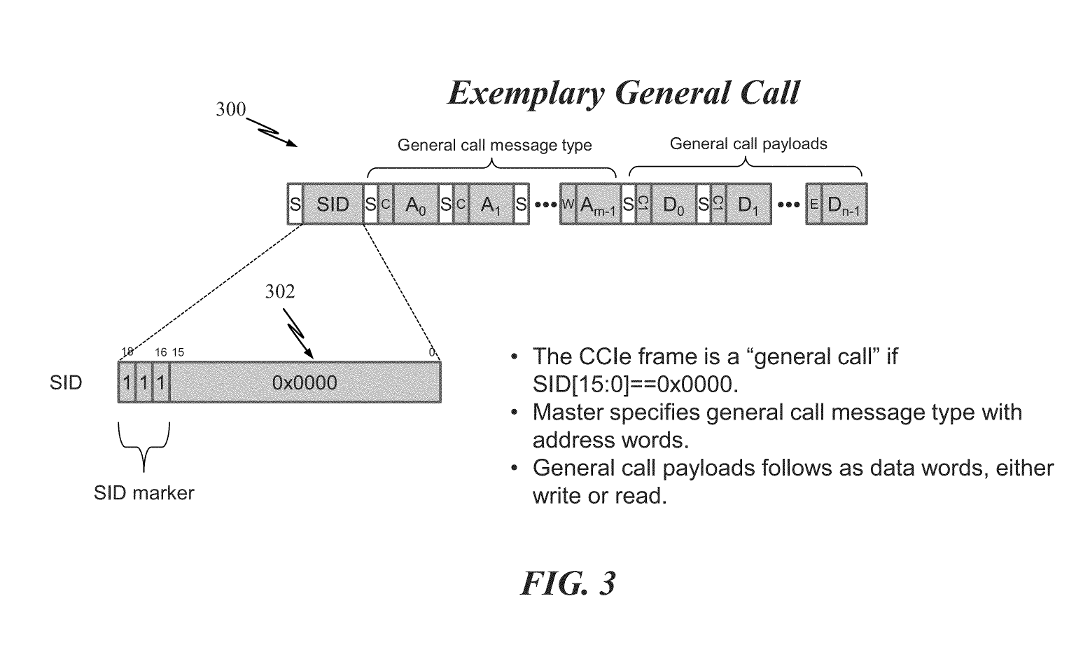

FIG. 3 is a conceptual illustration of a CCIe message frame or general call 300. A slave device identification (SID) portion/field 302 of the frame includes 16 bits (0-15) identifying a call type. A general call is defined when the SID is all zeroes (0x0000). For this general call, bits 16-18 of the SID portion 302 may be fixed to “111”, for example. This general call 300 is a broadcast write command or message to all slave devices coupled to the control data bus 108, so the SID portion/filed 302 does not specify a particular slave device. The master device 112 specifies the general call message type with address words and the general call payload(s) follow as data words to be written. In some embodiments, where the general call specifies a particular SID identifying a particular device, this may specify a read operation from that particular device.

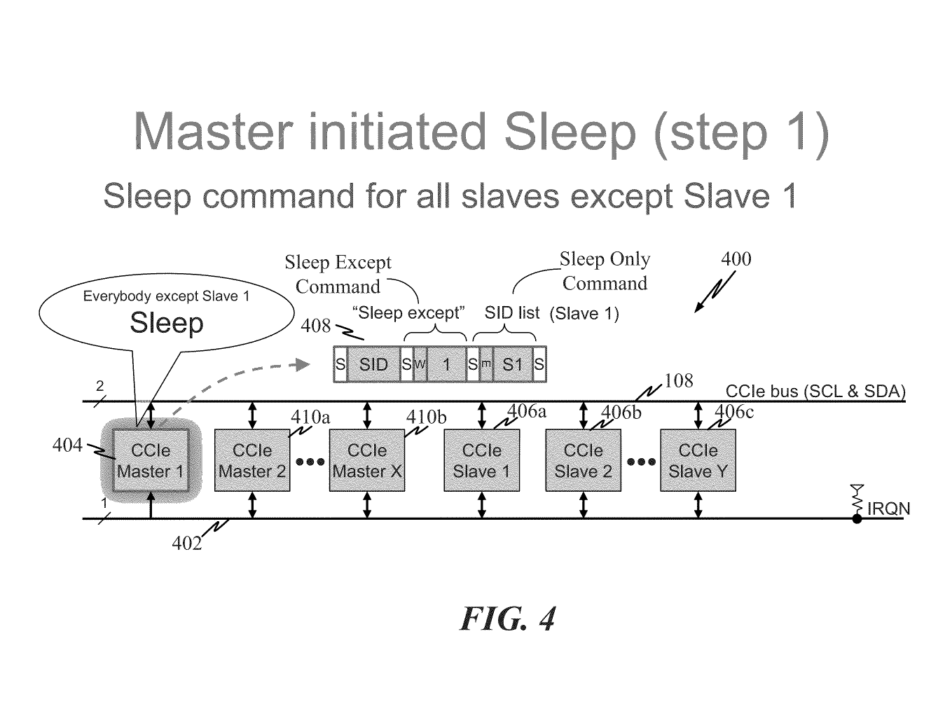

FIG. 4 conceptually illustrates an exemplary first step of a master device initiated sleep process. A circuit 400 may include a master device 404 coupled to one or more slave devices 406 via a control data bus 108 and an interrupt request bus 402. The master device 404 may send a sleep command to all slave devices 406 to go to sleep except for the first slave device 406, which will stay awake. In some implementations, such sleep command may also cause all other master devices 410a and 410b to go to sleep (e.g., the other master devices 410a and 410b are capable of switching between slave mode operation and master mode operation). The control data bus 108 may be used by the master device 404 to send the sleep command to the slave devices 406. The combination of the control data bus 108 and/or interrupt request bus 402 (e.g., a single line bus) may be used by the slave devices 406 and/or master device 404 to wake up the slave devices. In FIG. 4 the master device 404 is issuing a “sleep only” command 408. The sleep only command 408 identifies exactly which slave devices should go to sleep while all other slave devices (i.e., devices not identified in the sleep only command 408) stay awake. That is, a slave device reads the command 408 and if it is not identified by the command, then it may ignore the command (e.g., not enter sleep mode).

Alternatively, the master device 408 may send a “sleep except” command. The sleep except command is an inverse to the sleep only command. In other words, while the sleep only command positively identifies which slave devices should go to sleep, the sleep except command identifies exactly which slave devices should stay awake. Put differently, the sleep command positively identifies which slave devices stay awake and all other non-listed slave devices default to the sleep mode.

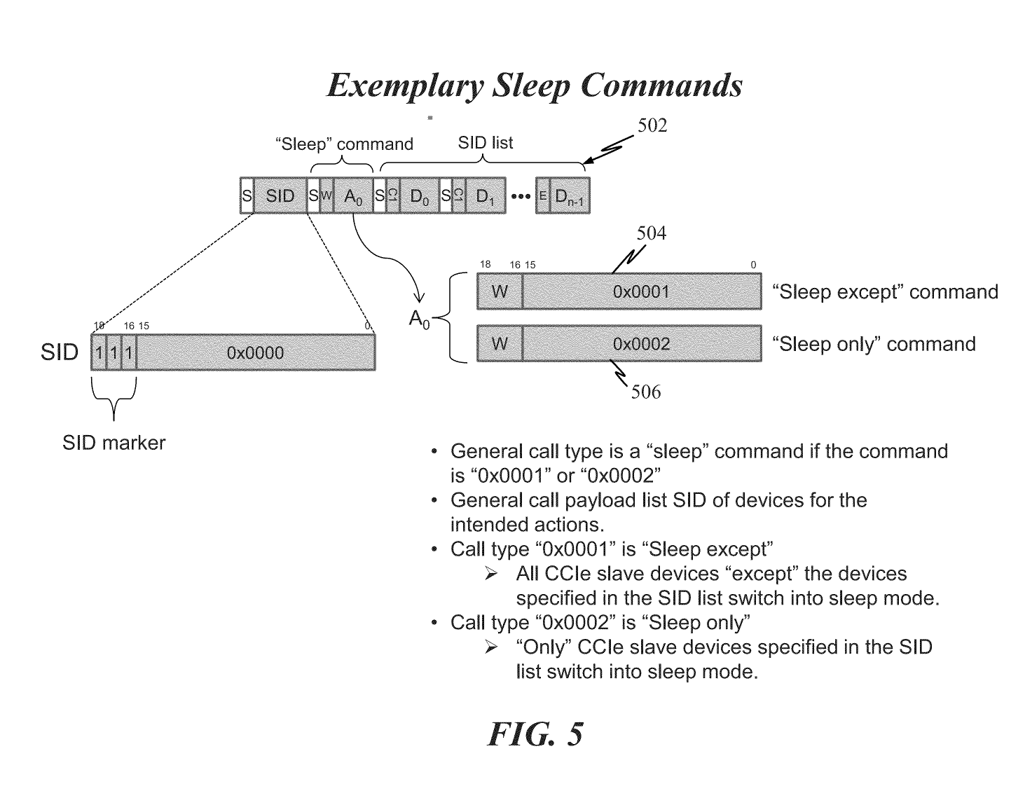

FIG. 5 conceptually illustrates two exemplary sleep commands. A sleep except command 504 may be defined to be a first code, such as 0x0001, and the sleep only command 506 may be defined to be a second code, such as 0x0002. For both commands the list of slave devices being positively articulated (i.e., enumerated or delineated) is specified in a SID list 502. For example, the sleep only command 504 of 0x0001 is followed by a SID list 502 that lists the slave devices by SID that are to go to sleep. Similarly, the sleep except command 506 of 0x0002 is followed by the SID list 502 that lists the slave devices by ID that are to stay awake.

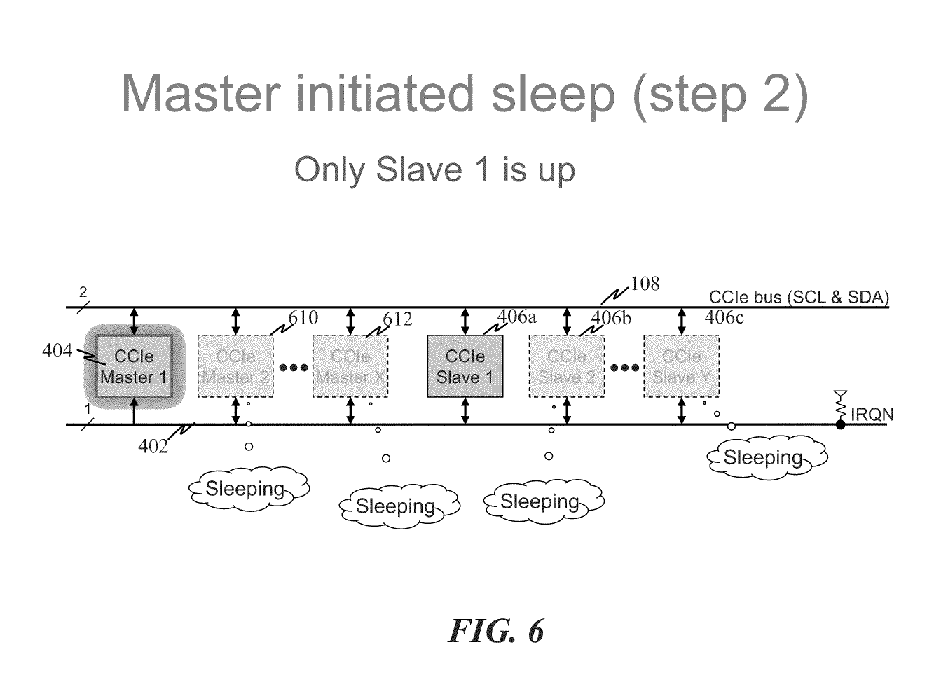

While FIG. 4 illustrated a first step of a master device initiated sleep process, FIG. 6 illustrates an exemplary second step of the master device initiated sleep process. More specifically, FIG. 6 illustrates that only two devices are awake, the master device 404 and the first slave device 406a. All other devices are asleep including a second master device 610, third master device 612, and other slave devices 406b and 406c. The slave devices 406a, 406b, and 406c are always slave devices, while the master devices 404, 610, and 612 can operate in a slave mode and can go to sleep both in the slave mode and in master mode.

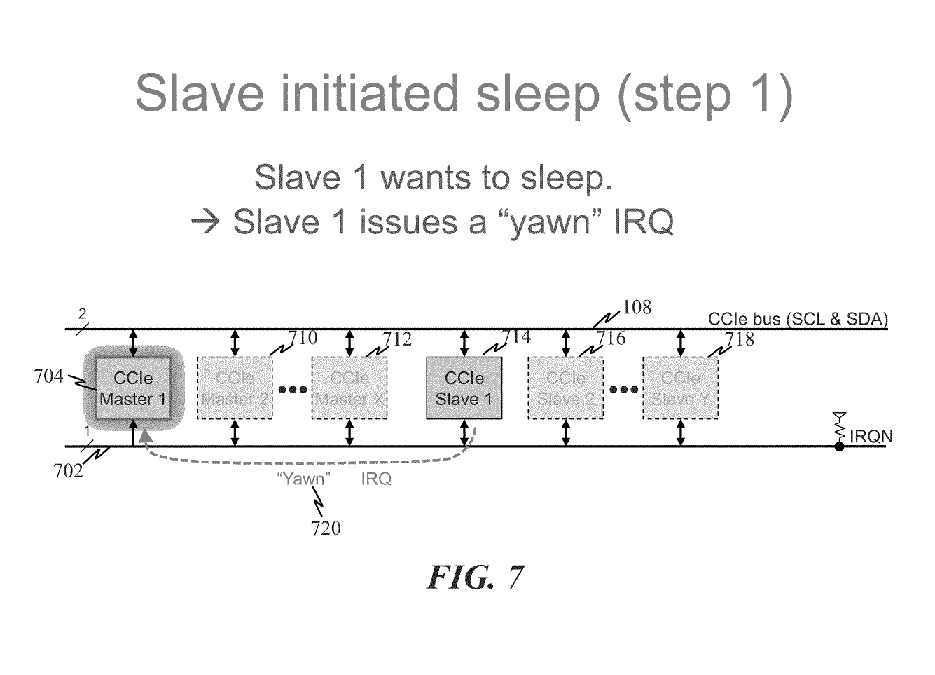

FIG. 7 illustrates an exemplary first step of a slave device initiated sleep process. A first slave device 714 wishing to go into the sleep mode (e.g., CCIe slave device 1) uses an interrupt request line 702 to send a sleep request (e.g., a “yawn”) to a currently active master device 704. The IRQ sleep request signal 720 is made by pulling the IRQ line low. In one implementation, the first master device 704 then receives the IRQ signal 720 and polls all awake slave devices 714 to determine which slave device sent the slave device initiated sleep request. The slave devices may be placed in groups as herein described and the first master device 704 only polls awake slave devices in the group to which the slave device belongs. In other words, the first master device 704 determines what group the slave device initiated sleep request came from and then only polls awake slave devices in that group.

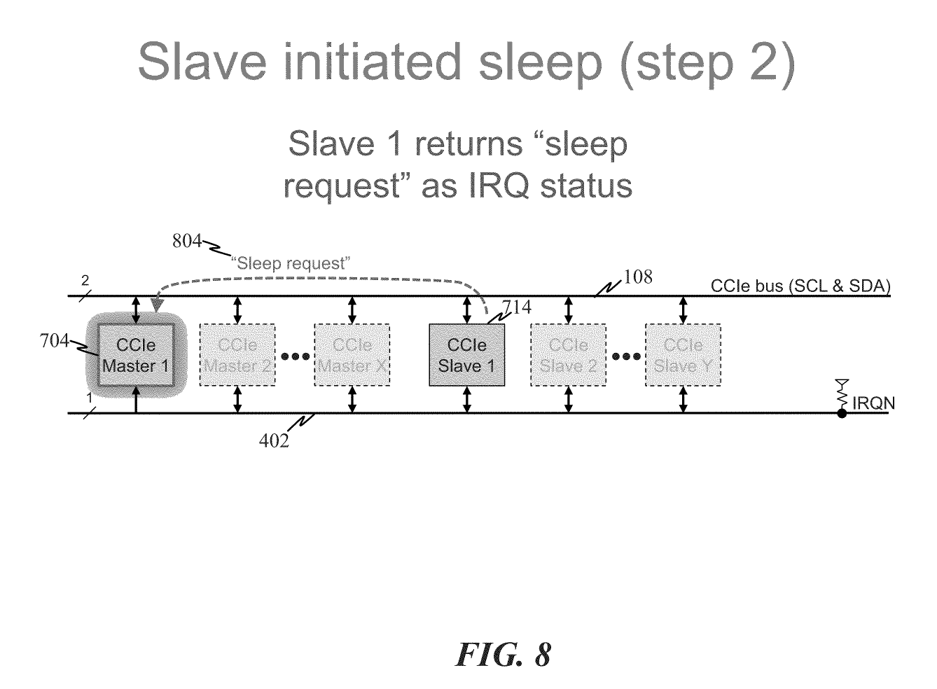

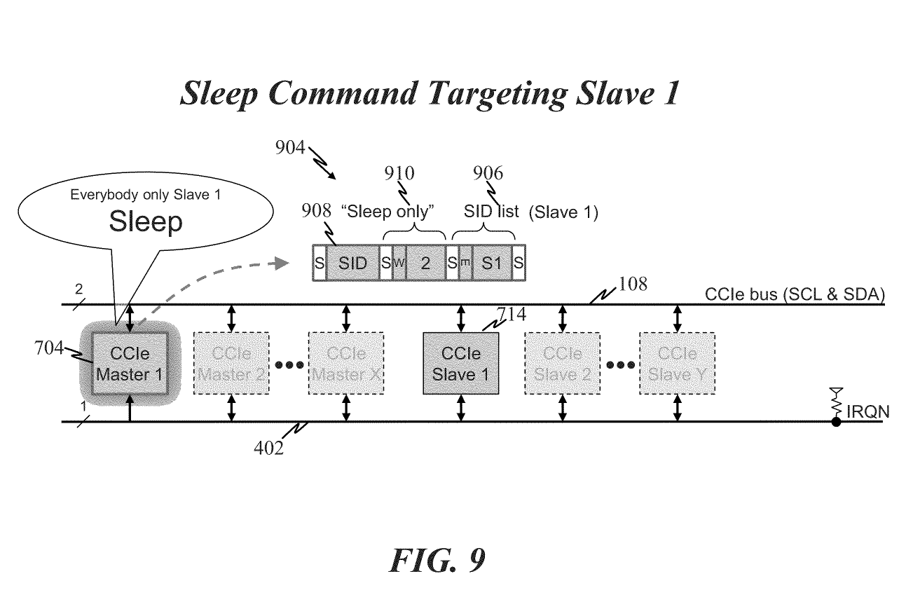

FIG. 8 illustrates an exemplary second step of the slave device initiated sleep process. The first master device 704 has received the slave device initiated sleep request 804 and the first master device 704 polls all awake slave devices to determine which slave device sent the slave device initiated sleep request 720. More specifically, the first master device 704 may send a status request command to the slave device 714 which returns a status of sleep request 804. For example, a lack of response from the slave device 714 may be understood to be that the slave device 714 is in a sleep mode. If the sleep request 804 is acceptable to the first master device 704 then the first master device 704 sends a sleep only command (as illustrated in FIGS. 9) listing only the slave device 714 in the SID list. That is, the sleep command instructs the requesting slave device 714 to go to sleep. The requesting slave device may then be added to a slave device sleep status list maintained by the master device. This slave device sleep status list allows the master device to keep track of which slave devices are sleep and/or which are awake.

FIG. 9 conceptually and graphically illustrates how a master device may send a sleep only general call command targeting a specific slave device. In this example, the first master device 704 broadcasts a sleep only general call command 904 to all devices coupled to the control data bus 108 (e.g., the SID field 908 is “0x0000” for “broadcasting” but message type field 910 defines “sleep only command”). Because the sleep only general call command 904 command is identified as a “sleep only command” by the message type filed 910, this means an SID list 906 is appended. The SID list 906 identifies the device(s) to which the sleep only command is targeted. In this example, the SID list 906 may identify only the first slave device 714 (S1). Although only a single device (S1) is listed in the SID list 906, multiple devices can be listed in an SID list.

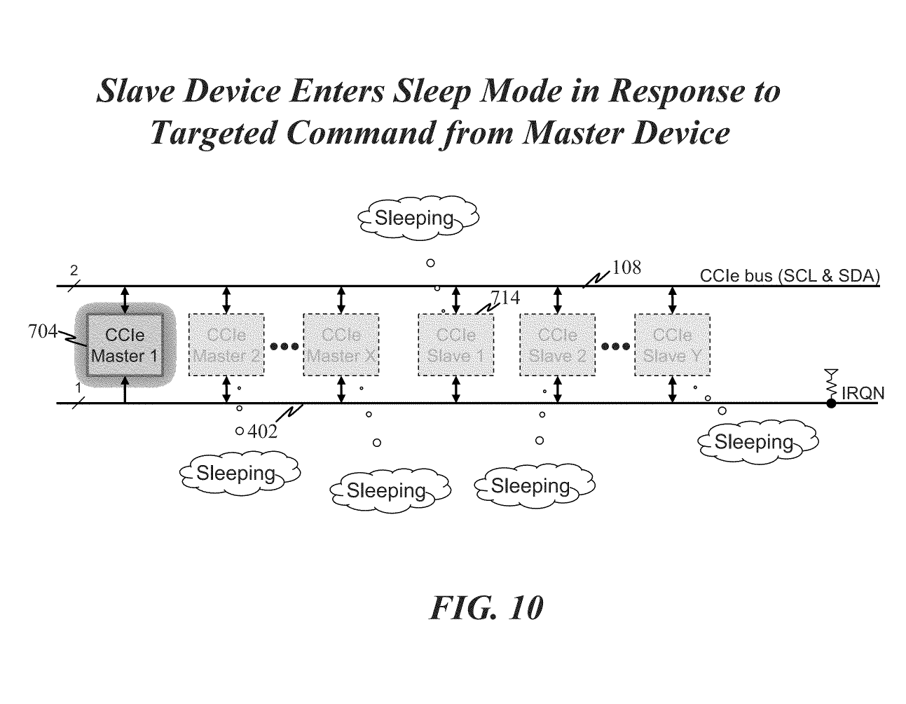

FIG. 10 conceptually and graphically illustrates how the targeted slave device 714 enters a sleep mode in response to a targeted sleep command from the master device 704. Additionally, the first master device 704 may enter into sleep mode itself.

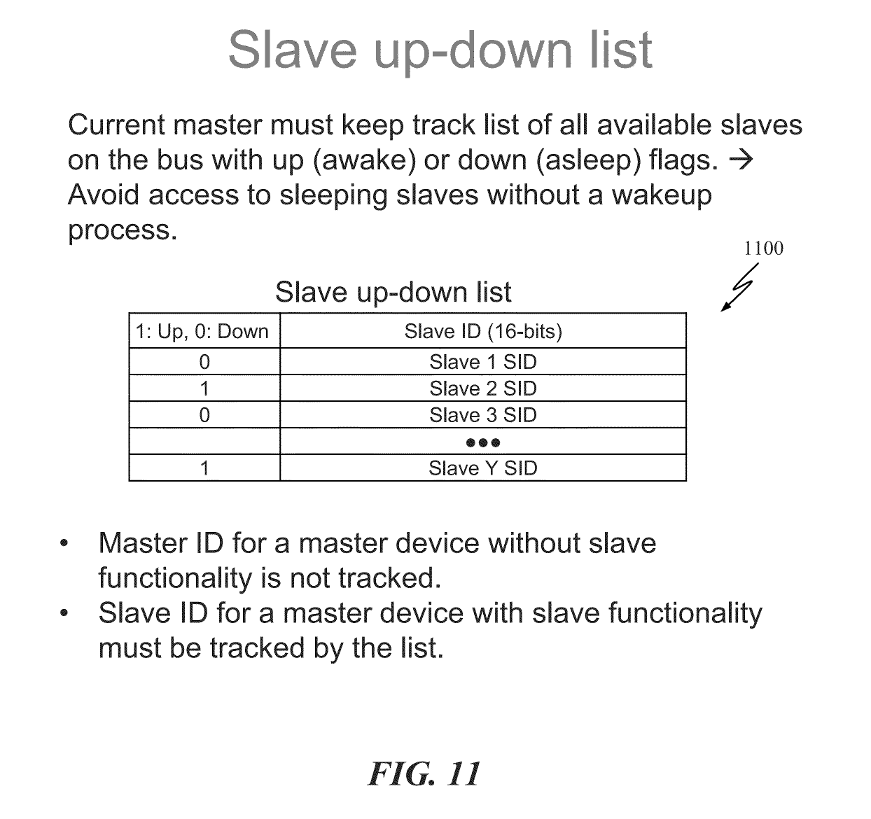

FIG. 11 conceptually illustrates that a master device may maintain a slave device sleep status list. This slave device sleep status list 1100 may allow the master device to always know which slave devices were put in the sleep mode. Although in one implementation the master device may maintain the slave device sleep status list 1100, the master device only needs to access the list that can be held by the baseband processor 104 (FIG. 1) and/or device 102. The current master device can keep track of and maintain a list of all available slave devices coupled to the control data bus with up (awake) or down (asleep) flags. This avoids trying to access any sleeping slave devices without a wake up process first. In some implementations, a master device may be capable of operating in both a slave mode (e.g., slave device functionality) and master mode (master device functionality) while another master device may only operate in a master mode (e.g., master device functionality). The master identifier (ID) for a master device without slave device functionality may not be tracked by the SID list 1100, but the slave device ID for a master device with slave device functionality may be tracked by the list 1100.

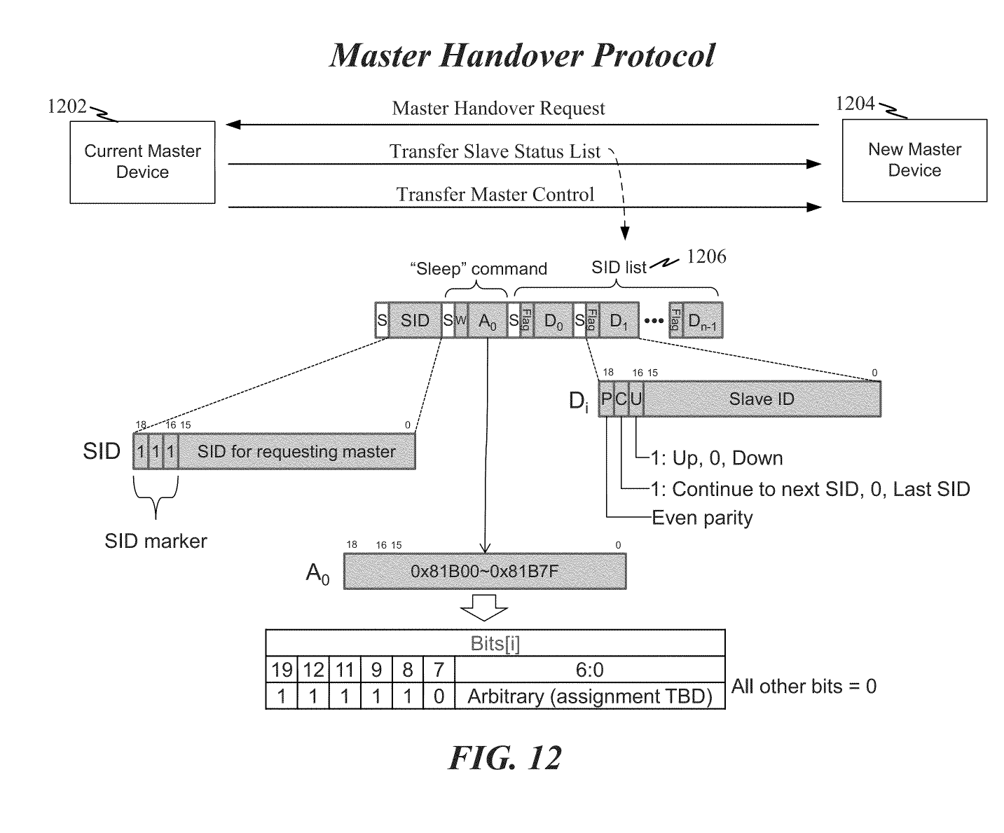

FIG. 12 illustrates an exemplary master device handoff protocol. In this example, an active master device 1202 receiving a master request from a non-active master device 1204 transfers the slave device sleep status list 1206 to the to-be master device 1204 before enabling the non-active master device to be active. The transfer of the slave device sleep status list 1206 may be performed over the control data bus 108 (FIG. 1).

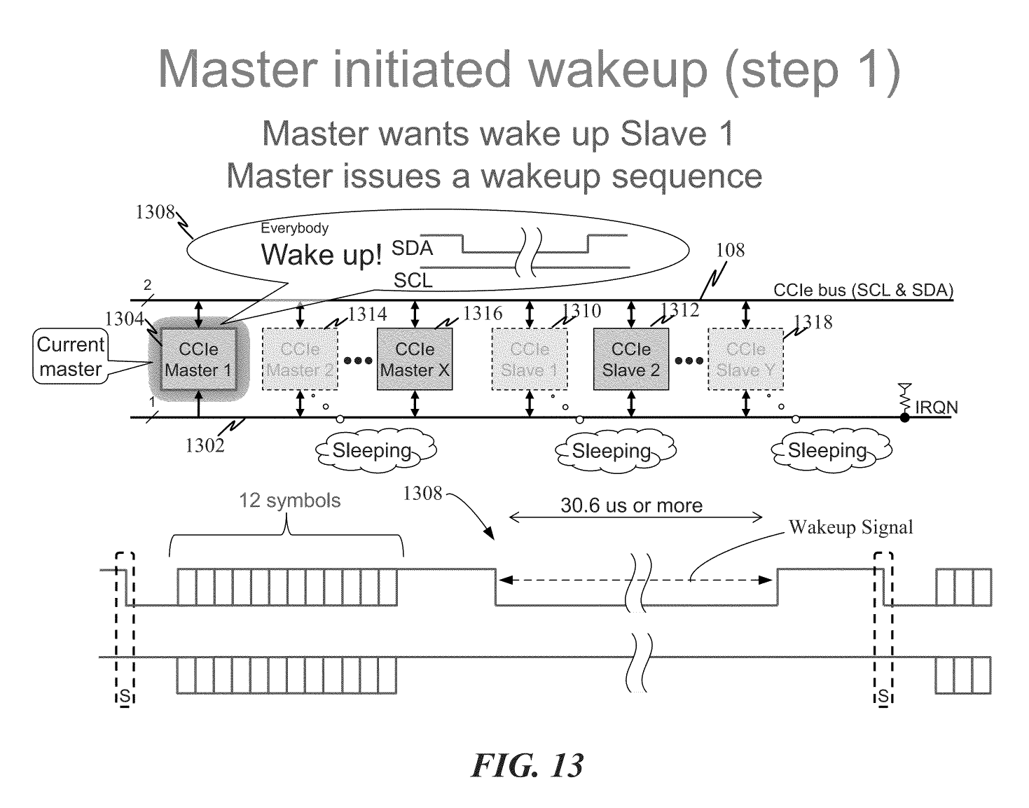

FIG. 13 illustrates an exemplary first step of a master device initiated wake up protocol. In this example, an active master device 1304 sends a global wake up signal 1308. Specifically, the active master device 1304 may pull down the SDA line of the control data bus 108 for a predetermined amount of time. For example, the control data bus 108 may be pulled down (e.g., pull to ground) for at least 30.6 μseconds and the slave devices 1310, 1312, 1318 and non-active master devices 1314, 1316 are configured to recognize this extended pull down as a wake up call. Accordingly, all sleeping devices wake up and, in one embodiment, undergo a reset. The awakened devices may send a wake up confirmation message (e.g., an interrupt signal over the interrupt bus or IRQ line 1302) to the master device 1304 that verifies receipt from all slave devices on the slave device sleep status list shown as asleep. Note that although the list is called a “slave device” sleep status list, any master device with sleep capability (e.g., capable of operating in sleep mode as well as master mode) may also be on the list as well.

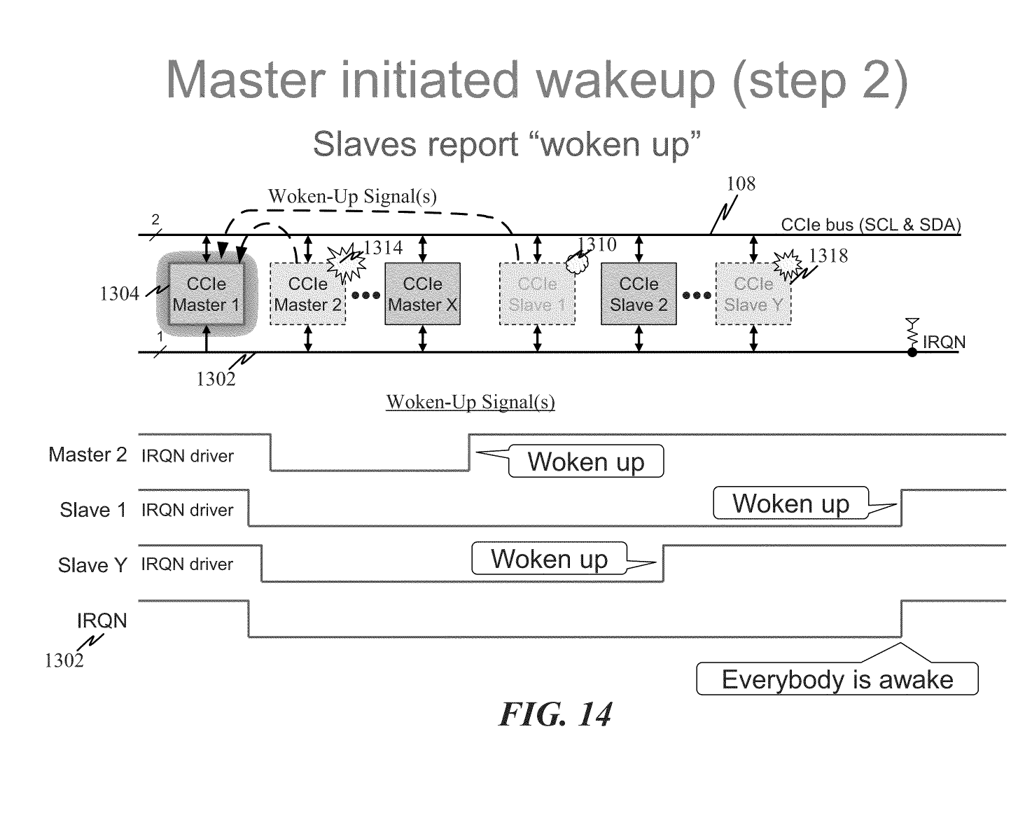

FIG. 14 illustrates an exemplary second step of a master device initiated wake up protocol. Once the sleeping devices 1314, 1310, and 1318 have awoken upon receipt of the wake up signal 1308, these devices 1314, 1310, and 1318 may signal their awakened status by initially pulling down the IRQ line 1302 during a wake up and reset period, and then release the IRQ line 1302 when finished. In other words, the IRQ line 1302 is driven to ground upon the first device to act and stays grounded until the last device has finished. The master device 1304 can then poll all devices listed on the maintained slave device sleep status list to verify that the previously sleeping devices 1314, 1310, 1318 are now awake (i.e., normal mode). Consequently, the master device 1304 sends the wake up signal 1308 on the SDA line, receives an indication of all devices awake on the IRQ line 1302, and verifies status on the SDA line by polling the status registers of each device.

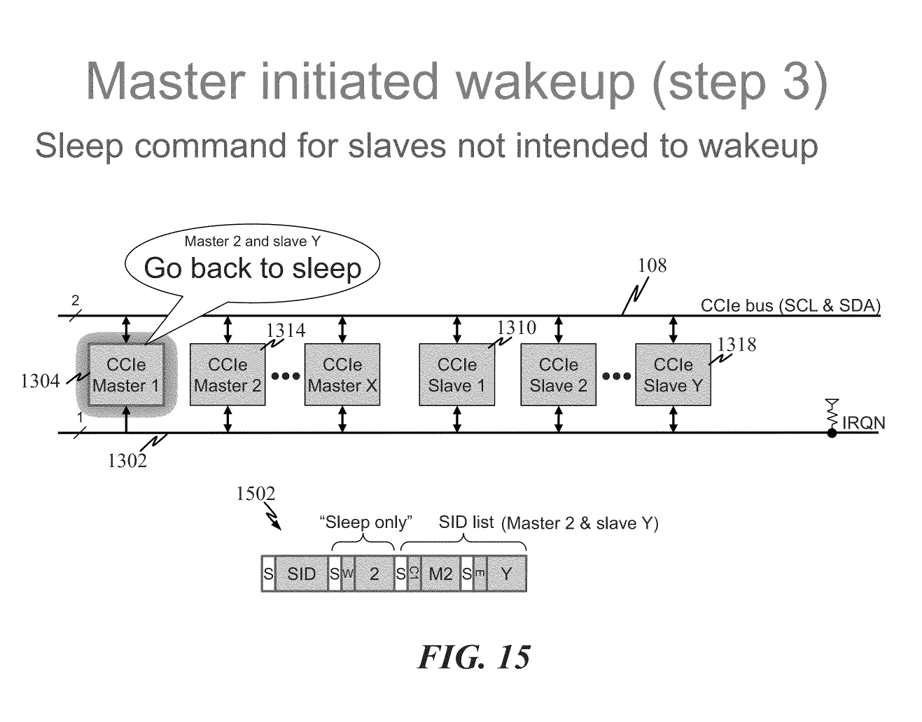

FIG. 15 illustrates an exemplary third step of the master device initiated wake up protocol. In this exemplary step, the master device 1304 puts selected devices back to sleep. Because the wake up call 1308 is a global wake up call, all sleeping devices are awoken even if only one sleeping device needed awaking Therefore, after waking-up all sleeping devices, the master device 1304 may then proceed to put those devices that were incidentally awoken back to sleep. In the illustrated example of FIG. 15, the master device 1304 is putting a second master device 1314 and a second slave device 1318 back to sleep by issuing the sleep only command 1502 on the SDA line of the control data bus 108.

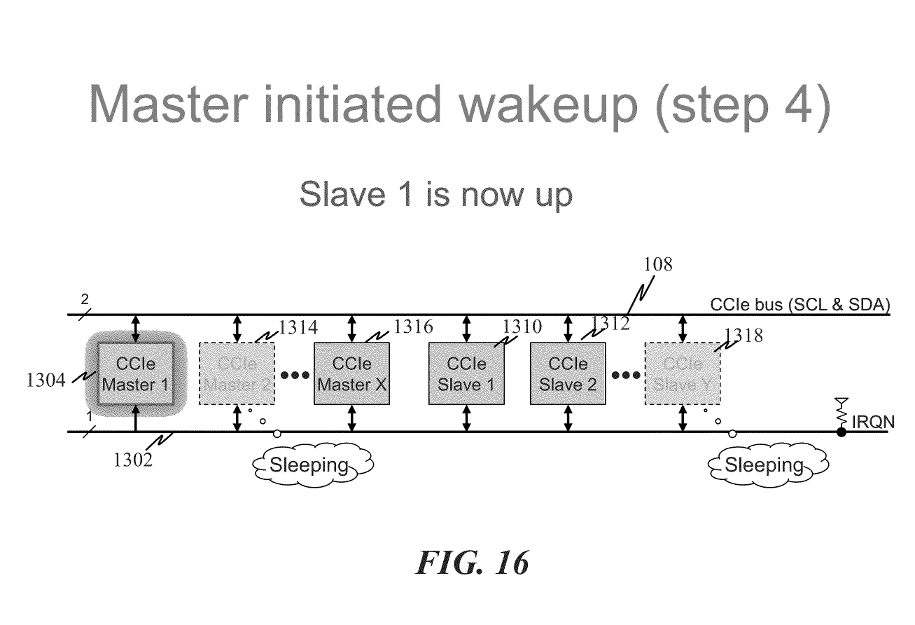

FIG. 16 illustrates an exemplary fourth step of the master device initiated wake up protocol. In this exemplary step, the active master device 1304 previously sent a global wake up signal, woke up all sleeping devices, and then placed all the woken up devices back to sleep mode except for the target/desired slave device 1310 (e.g., the slave device that necessitated the wake up call). Referring back to FIG. 13, the second master device 1314, the first slave device 1310, and the second slave device 1318 were initially asleep and the first master device 1304 wanted to wake up the first slave device 1310. In FIG. 16, the first slave device 1310 is awake and the second master device 1314 and second slave device 1318 are back asleep.

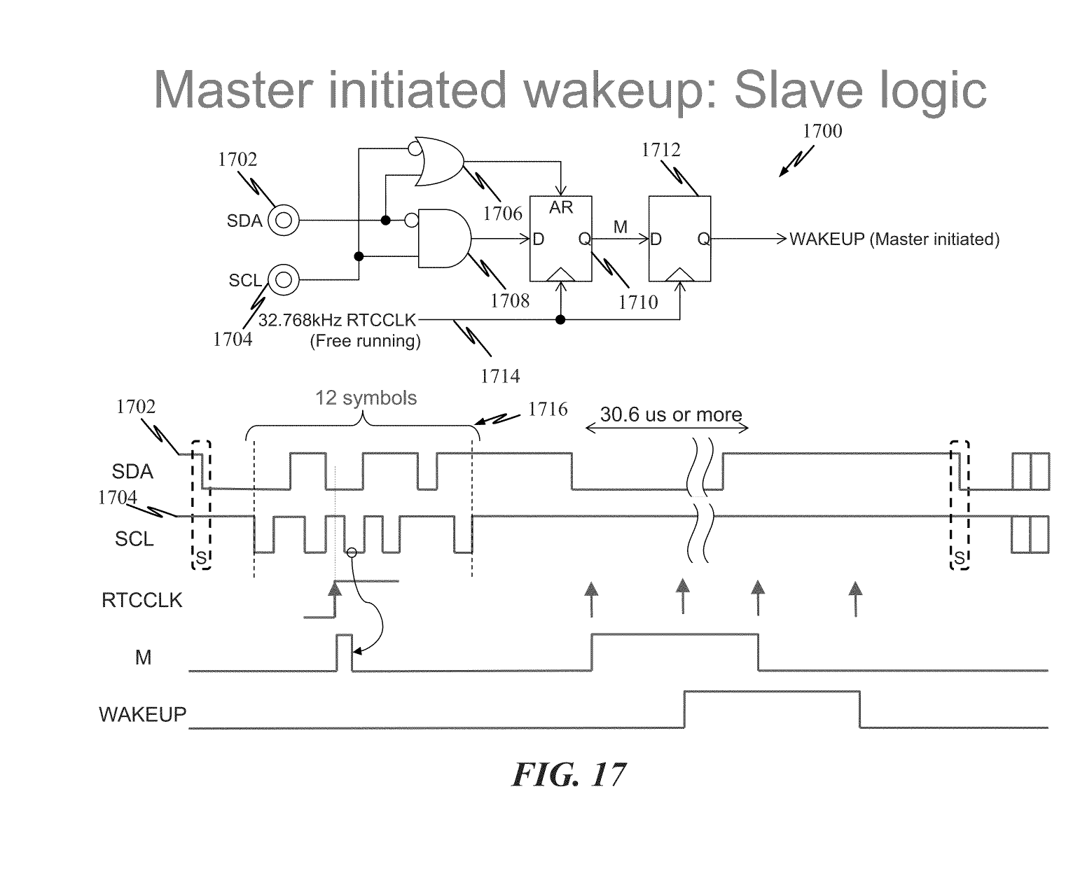

FIG. 17 illustrates exemplary slave device logic to receive a master device initiated wake up signal. In this example, the slave device may include a receiver logic circuit 1700 adapted to sense a wake up signal on the control data bus (e.g., Serial Data (SDA) line 1702 and a Serial Clock (SCL) line 1704). The receiver logic circuit 1700 may include an OR gate 1706 and a AND gate 1708 with the gates outputs are connected to a first D flip-flop 1710 whose Q output (M) is fed into a second D flip-flop 1712. A real time clock (RTCCLK) line 1714 is coupled to both D flip-flops 1710 and 1712. A clock signal may be embedded within transcoded symbols over the control data bus such that outputs from the SDA line 1702 and the SCL 1704 are combined into a stream of symbols 1716 from which the clock signal can be extracted. Under the normal operating protocols, the SDA line 1702 is never pulled low for this extended period of time. Therefore, pulling the SDA line 1702 low for a time of at least 30.6 μseconds is used to trigger a wake up of the sleeping devices.

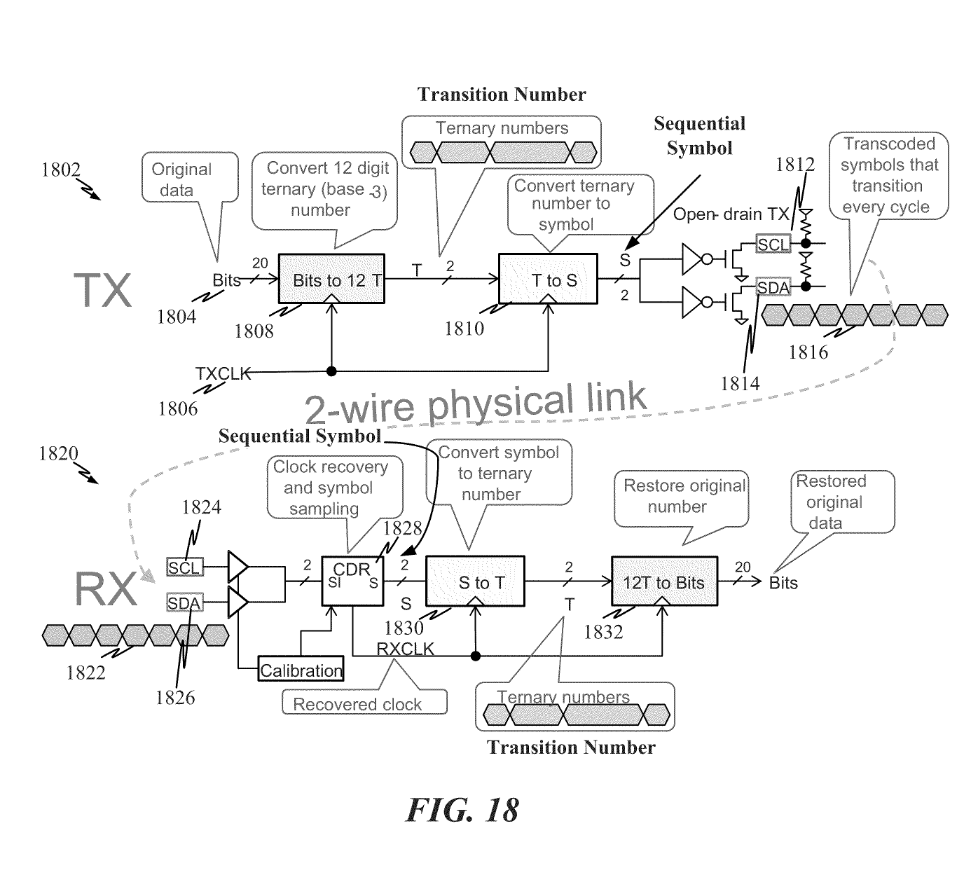

FIG. 18 is a block diagram illustrating an exemplary method for transcoding of data bits into transcoded symbols at a transmitter to embed a clock signal within the transcoded symbols. At the transmitter 1802, a sequence of data bits 1804 are converted into a ternary (base 3) number (i.e., a “transition number”), and the ternary numbers are then converted into (sequential) symbols which are transmitted over a clock line SCL 1812 and a data line SDA 1814.

In one example, an original 20-bits of binary data is input to a bit-to-transition number converter block 1808 to be converted to a 12-digits ternary number. Each digit of a 12-digits ternary number represents a “transition number”. Two consecutive transition numbers may have the same numbers. Each transition number is converted into a sequential symbol at a transition-to-symbol block 1810 such that no two consecutive sequential symbols have the same values. Because a transition is guaranteed at every sequential symbol, such sequential symbol transition may serve to embed a clock signal. Each sequential symbol 1816 is then sent over a two wire physical link (e.g., I2C control data bus comprising a SCL line 1812 and a SDA line 1814).

At a receiver 1820 the process is reversed to convert the transcoded symbols back to bits and, in the process, a clock signal is extracted from the symbol transition. The receiver 1820 receives a sequence of sequential symbols 1822 over the two wire physical link (e.g., I2C control data bus comprising a SCL line 1824 and a SDA line 1826). The received sequential symbols 1822 are input into a clock-data recovery (CDR) block 1828 to recover a clock timing and sample the transcoded symbols (S). A symbol-to-transition number converter block 1830 then converts the transcoded (sequential) symbols to a transition number, i.e., one ternary digit number. Then, a transition number-to-bits converter 1832 converts 12 transition numbers to restore 20 bits of original data from the 12 digit ternary number.

This technique illustrated herein may be used to increase the link rate of a control data bus 108 (FIG. 1) beyond what the I2C standard control data bus provides and is referred hereto as CCIe mode. In one example, a master node and/or a slave node coupled to the control data bus 108 may implement transmitters and/or receivers that embed a clock signal within symbol transmissions (as illustrated in FIG. 18) in order to achieve higher bit rates over the same control data bus than is possible using a standard I2C control data bus.

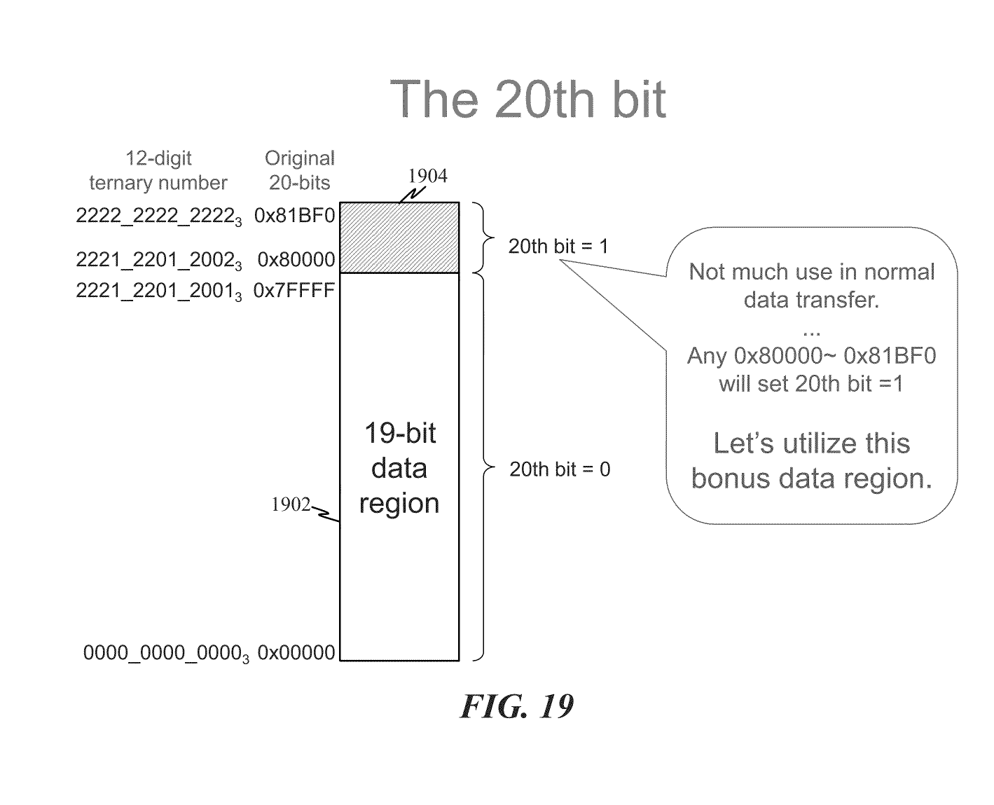

FIG. 19 illustrates an example of a 20-bit region comprising a 19 bit data region 1902 and an additional 20^{th} bit region 1904. Note that, when first bit is referred to as “bit 0”, then the 20^{th} bit is referred to as “bit 19”. That is, as is typical in the computer sciences, counting bit wise begins at zero, and bit 19 is the 20^{th} bit. Here, the bits 0-18 are represented within the ternary number range of 0000_{—}0000_{—}0000₃ to 2221_{—}2201_2001₃. The ternary numbers in the range of 2221_{—}2201_{—}2002₃ to 2222_{—}2222_{—}2222₃ are unused. Consequently, the ternary number range 2221_{—}2201_{—}2002₃ to 2222_{—}222_{—}2222₃ may be used to represent bit 19 (i.e., 20^{th} bit). That is, 2221_{—}2201_{—}2002₃ ternary is 1000 0000 0000 0000 0000 binary (0x80000 hexadecimal) and 2222_{—}2222_{—}2222₃ ternary (0x81BF0) is the largest 12 digit ternary number possible. In one implementation, the 20^{th} bit data region may be used to send commands between the master device and slaves devices, including the sleep only command and the sleep except commands.

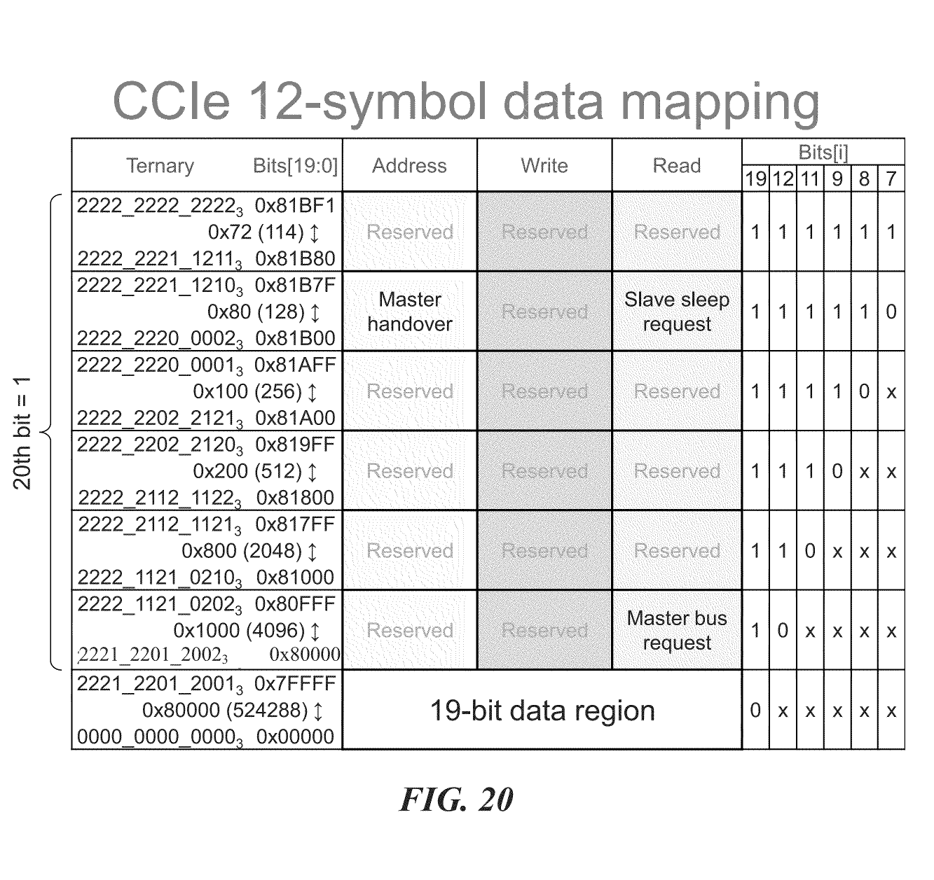

FIG. 20 illustrates that besides the bit 19 being set for numbers 2221_{—}2201_{—}2002₃ to 2222_{—}2222_{—}2222₃, that range of numbers can be subdivided into six sections. The subrange from 2222_{—}2220_{—}0002₃ (0x81B00) to 2222_{—}2221_{—}1210₃ (0x81B7F) can be used for slave device sleep requests as well as master device handovers. As previously mentioned, CCIe is a multi-master control data bus architecture and control of the control data bus 108 can be transferred from one master device to another master device. The subrange from 2221_{—}2201_{—}2002₃ (0x80000) to 2222_{—}1121_{—}0202₃ (0x80FFF) can be used for master control data bus requests.

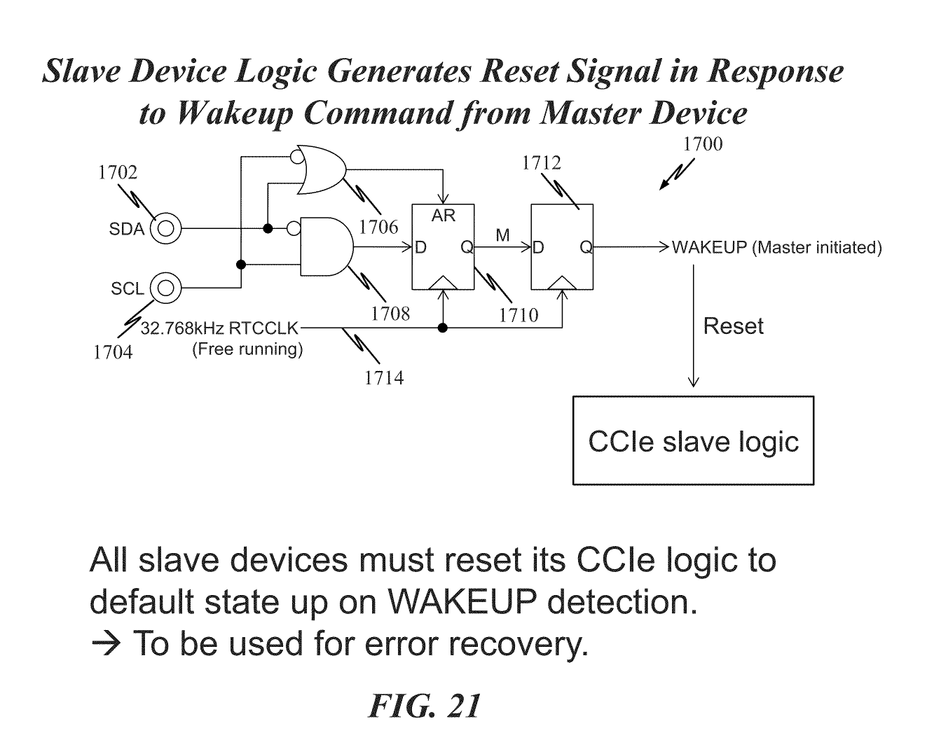

FIG. 21 illustrates an exemplary slave device logic that generates a reset signal upon sensing a master device initiated wake up. As discussed with reference to FIG. 17, the slave device may include a receiver logic circuit 1700 adapted to sense a wake up signal on the control data bus. In one example, after a master device initiates a global wake up call, the woken up slave devices may reset their CCIe logic as part of an error recovery process.

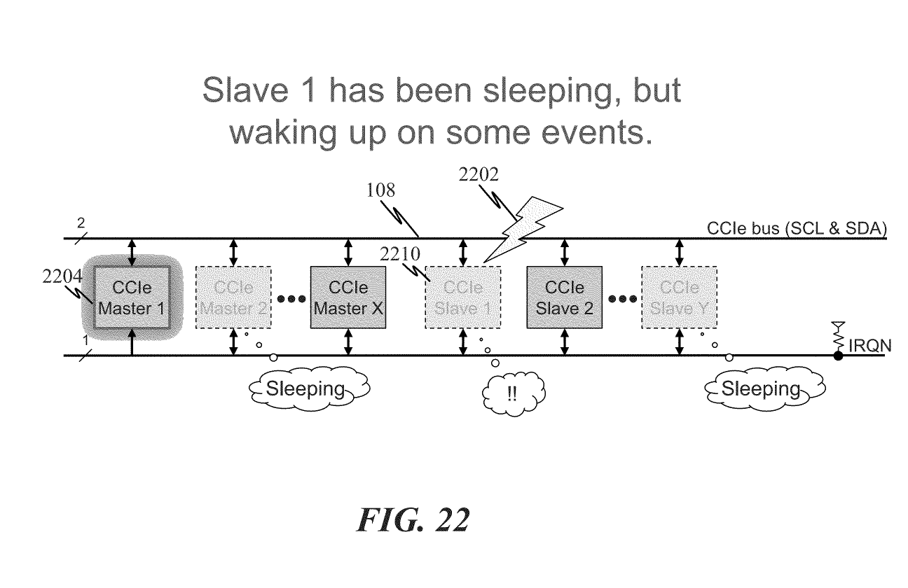

FIG. 22 illustrates a scenario in which a trigger external to a master device is triggering interaction with a sleeping slave device. That is, even when in a sleep mode, the sleeping slave devices still listen and can be woken up by use of the receiver logic circuit 1700 described in FIG. 17 or other trigger signal 2202 external to the control data bus 108. Such trigger signal 2202 may be sent by a device or component within or coupled to a slave device. For example, a temperature sensor, gravity sensor, accelerometer, etc., may send such trigger signal 2202 upon a change in state or conditions being sensed, thereby waking up a sleeping slave device 2210. This allows the sleeping slave device 2210 to receive a request from another device (e.g., either coupled to the control data bus 108 or external to the control data bus 108) to interact with that other device. However, the sleeping device 2210 needs to wake up first and notify the master device 2204 of this change in state. The another device may be another slave or an external device (e.g., a device not directly coupled to the control data bus 108) in communication with the sleeping slave device 2210. In one example, the another device may be any non-master device (i.e., any device that is not the currently active master device maintaining the slave device sleep status list).

### Exemplary Method for Grouping Slave Devices on an I2C Control Data Bus

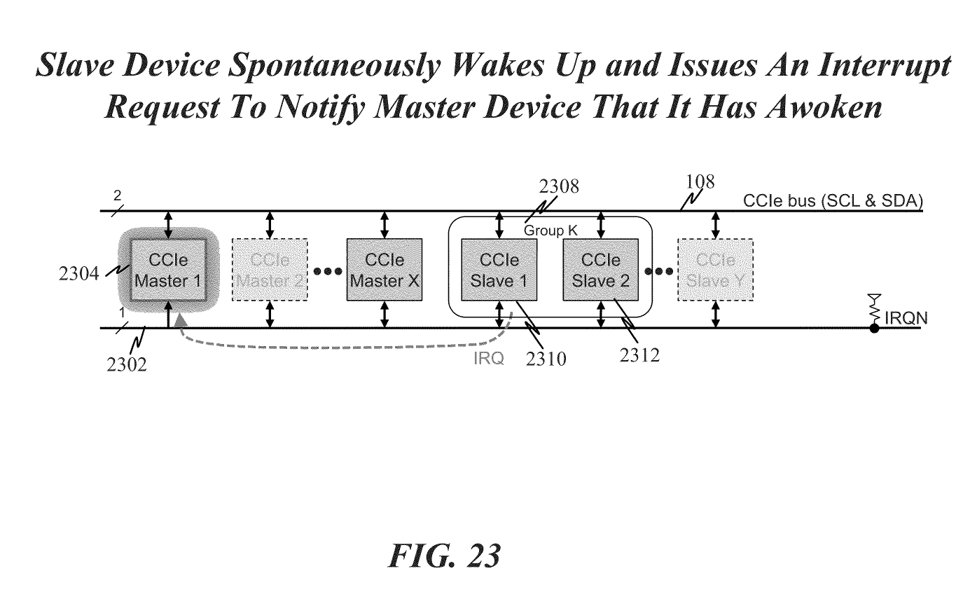

FIG. 23 illustrates a first approach of how a slave device may spontaneously wake up and notify the master device that it has woken up by issuing an interrupt request (IRQ). For example, a first slave device 2310 wakes up and notifies an active first master device 2304 that it is awake by issuing an IRQ. In this example, the first slave device 2310 may be in a logical group (Group K) 2308 with a second slave device 2312. When using such groupings, each group may have its unique IRQ signature. For example, a minimum time is called T₀ and the groups can be assigned interrupts having a time period based on multiples of T₀. For example, a first group (Group A) holds down the IRQ line 2302 for a time period of T₀ to initiate an IRQ, a second group B holds down the IRQ line for a period of time that is twice T₀, a third group C holds down the IRQ line 2302 for a period of time that is three times T₀, and so forth. By measuring how long the IRQ line 2302 is pulled down, the active first master device 2304 can identify which group issued the IRQ and then only poll the status of members of that group. This saves time over polling every device on the IRQ line 2302. There are other ways to uniquely identify groups than the just described pulse width variation, and any manner of unique group identification can be employed, or none at all if desired.

In this grouping implementation, one problem that can arise is when one member of a group has a spontaneous wake up feature (wherein the slave device can wake itself up) and its wake up notification coincides with an already awake group member's interrupt IRQ for any reason. The active master device 2304 sees one interrupt and polls the members of the group that are awake looking to learn or identify which member made the request. The active first master device 2304 finds the already awake member making the IRQ and does not poll the first slave device 2310 because, according to the maintained slave device sleep status list, the slave device 2310 is asleep. The first master device 2304 stops because the asleep devices in the group must be woken up before they can be polled. This is not ideal because in order to poll the sleeping group members all sleeping devices are waken up with the global wake up call. That is, the first master device 2304 may be unaware that the first slave device 2310 has spontaneously awoken and issued the IRQ.

Note not all slave devices have the spontaneous wake up feature, and one solution is to always place devices with the spontaneous wake up feature in a group by themselves (i.e., group of size 1). A downside to always placing devices with the spontaneous wake up feature in their own individual group is this will increase the number of groups and have negative consequences especially if there are many devices with the spontaneous wake up feature. However, the more important upside is when the devices with the spontaneous wake up feature are in their own group, no global wake up call is needed. Rather, after receiving the interrupt (IRQ) signal from a recently awoken slave device, the active first master device 2304 just updates the status to show that this particular device is now in the normal mode of operation.

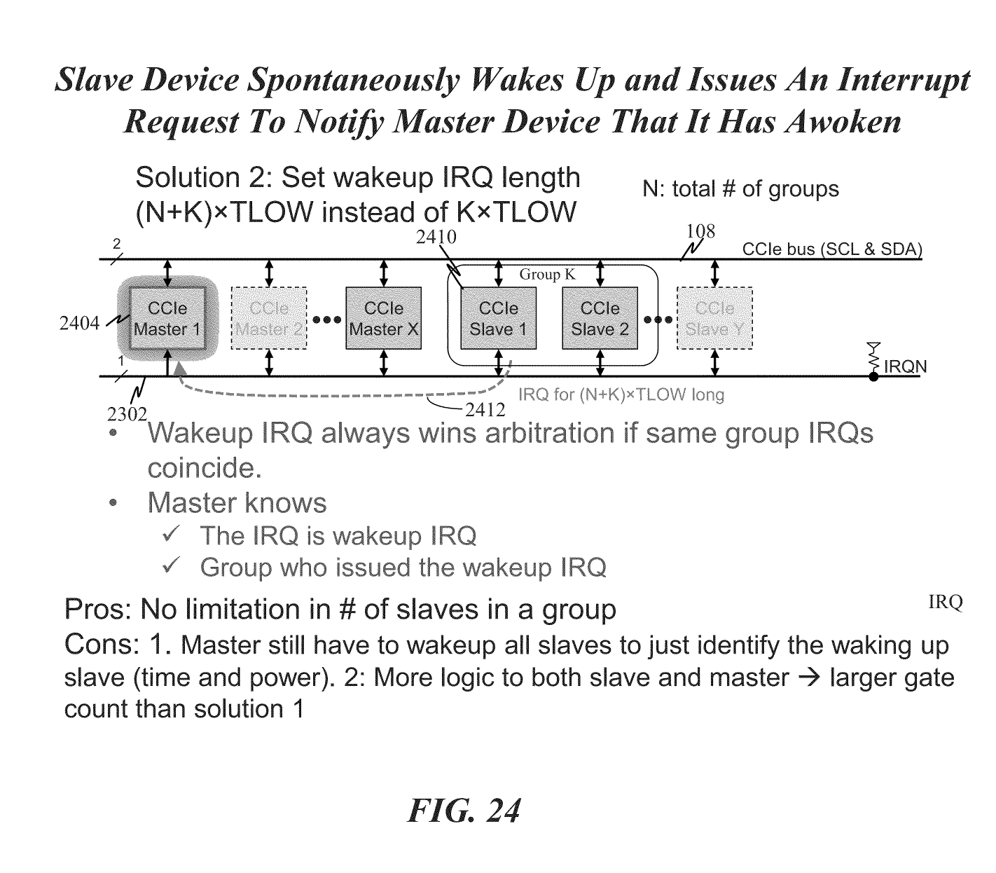

FIG. 24 illustrates a second approach of how a slave device 2410 may spontaneously wake up and notify a master device 2404 that it has woken up by issuing an interrupt request (IRQ) 2412. In this approach, the wake up IRQ 2412 may be lengthen to be (N+K) times T₀ (where T₀=TLOW, N is the total number of groups, and K is the index for that particular group). Therefore, when a regular interrupt coincides with a wake up IRQ 2412, the longer IRQ wins the arbitration (i.e., the wake up IRQ wins). However, even after addressing the problem of IRQ collisions and correctly identifying the proper group, in order to poll the sleeping group members all sleeping devices are awoken with the global wake up call, and this makes this second approach inferior to the first approach of isolating all spontaneous wake up capable devices into their own one device group.

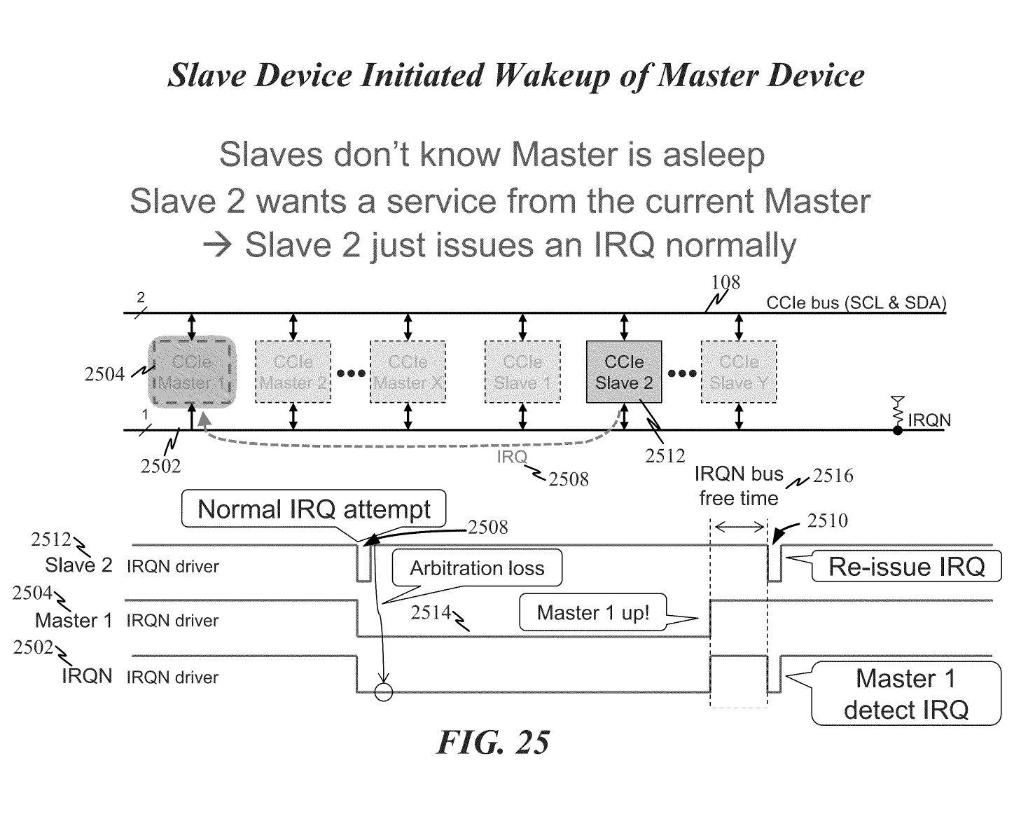

FIG. 25 illustrates an implementation where a slave device 2512 initiates wake up of a sleeping master device 2504. The slave device 2512 is awake in normal operation and requests a service from the master device 2504 by a normal interrupt signal 2508 attempt over an IRQ line 2502. The interrupt signal 2508 may be implemented, for example, by pulling the interrupt line/bus 2502 low for a first predetermined period of time. This first IRQ 2508 causes the master device 2504 to start waking up. As part of the wake up process, the master device 2504 is configured to pull the IRQ line 2502 low or to ground (see master device pull down period 2514) for a second predetermined period of time until the master device 2504 is fully awake at which time the IRQ line 2502 goes high. Because the first predetermined period of time is shorter than the second predetermined period of time, the slave device 2512 recognizes that its interrupt signal 2508 was overwritten or conflicted with another signal on the IRQ line/bus 2502 (i.e., there was contention on the interrupt line/bus 2502 with another device). The second predetermined period of time may be intentionally set to be longer than any possible interrupt signal from the slave devices in order to allow a sleeping master device to take advantage of the conflict arbitration mechanism on the IRQ line/bus 2502 to wake up. That is, the slave devices may be configured to retry/resend an interrupt signal (after the interrupt line/bus 2502 goes high again) if it notices that a conflicting signal has been issued on the interrupt line/bus 2502.

In this example, the slave device 2512 sends its interrupt signal 2508 by pulling the IRQ line/bus 2502 low for the first predetermined period of time. Upon expiration of the first predetermined period of time, the slave device 2512 releases the IRQ line/bus 2502 (e.g., so the interrupt line/bus 2502 should go high again). But rather than going high, the interrupt bus/line 2502 remains low due to the master device 2504 pulling the IRQ line/bus 2502 low for the second predetermined amount of time. Consequently, the slave device 2512 knows that its IRQ signal 2508 was not recognized. After sensing the IRQ line 2502 is high for a period of time (i.e., an IRQN bus free time 2516), the slave device 2512 issues a second IRQ signal 2510 (as part of the IRQ line/bus arbitration process) which the fully awake master device 2504 now detects and sends a response to slave device 2512. For example, the master device 2504 may send status requests to the slave device 2512 which may be understood by the slave device 2512 to be a response to its second interrupt signal 2510.

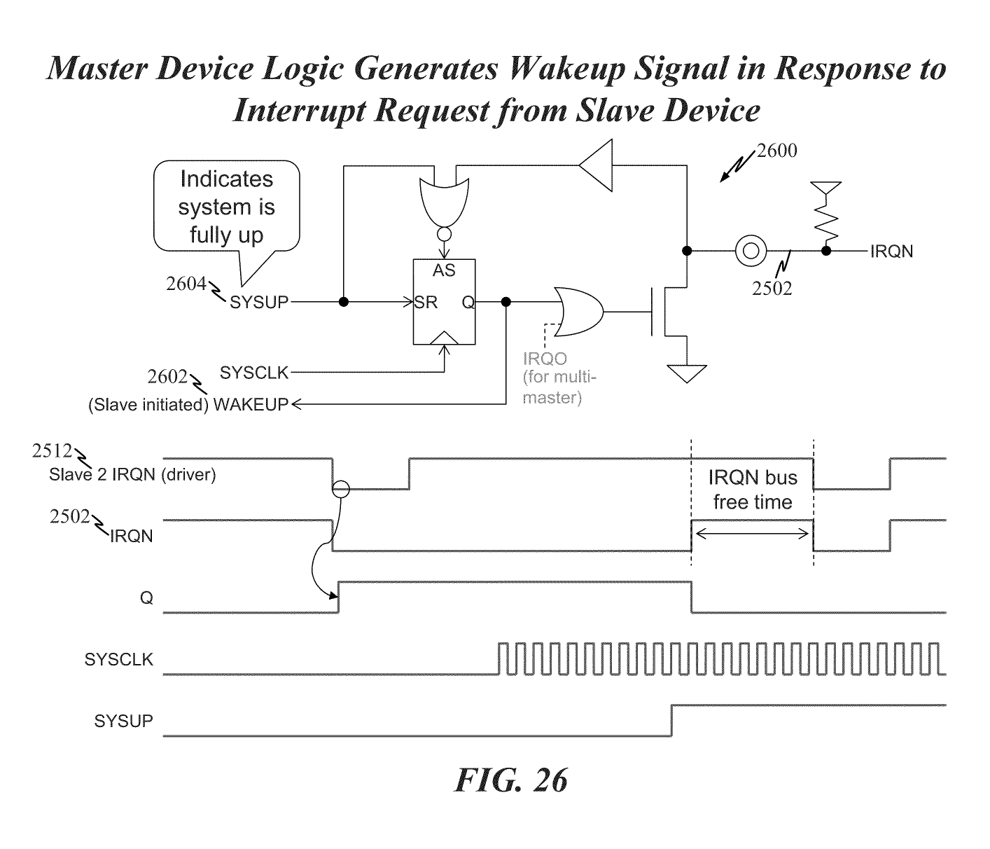

FIG. 26 illustrates an exemplary master device receiver logic 2600 that generates a wake up signal 2602 in response to interrupt request from a slave device. The slave device pulls the IRQ line 2502 low causing the active master device to begin waking up. When the low IRQ line 2502 (caused by the slave device) is over, the IRQ line 2502 stays low until the active master device is fully awake and lets the IRQ line 2502 return to high and pulls up a SYSUP system up indicator line 2604. After sensing the IRQ line 2502 is high for a period of time (i.e., the IRQN bus free time), the slave device issues a second IRQ which the fully awake active master device detects and responds to. Therefore, for a slave device wanting to interact with the sleeping active master device, the slave device issues two IRQs, the first IRQ wakes up the master device, and the second IRQ lets the master device know that the slave device is requesting attention. The master device polls the status register in the slave device to determine what the slave device wants.

Exemplary Master Device and Operation thereof

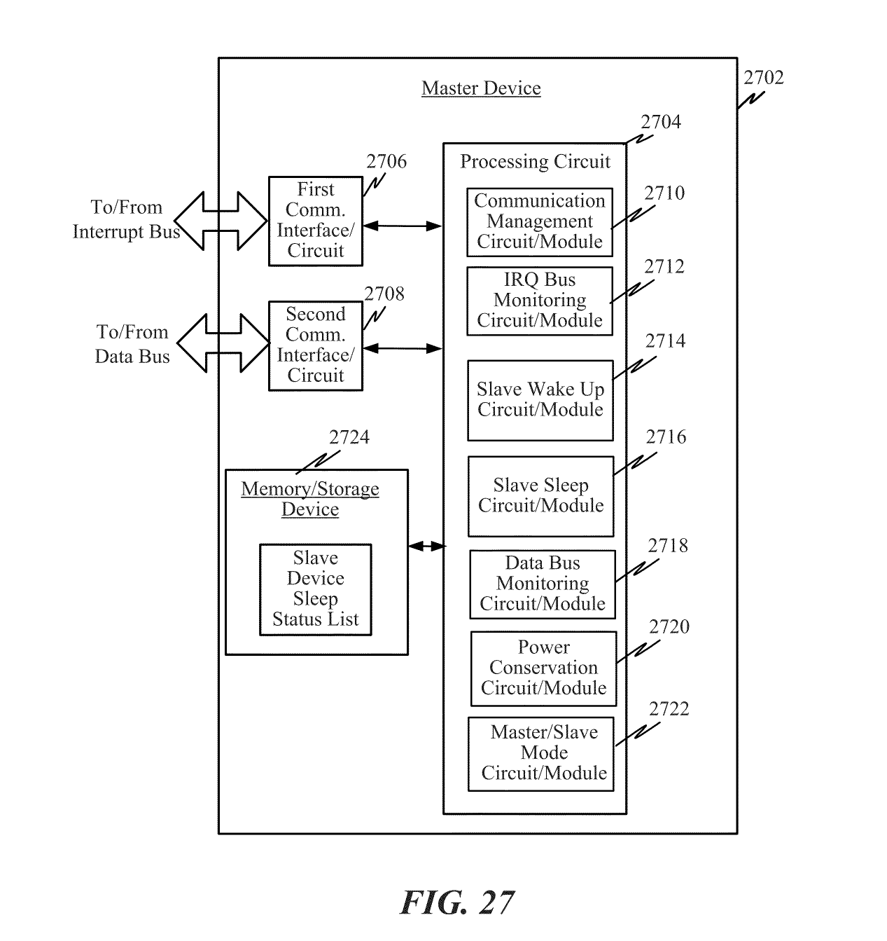

FIG. 27 is a block diagram illustrating an exemplary master device 2702 adapted for monitoring and controlling sleep modes of slave devices a shared control data bus controlled by the master device. The master device 2702 may implement one or more features described and/or discussed with reference to FIGS. 1-26. The master device 2702 may include a first communication interface/circuit 2706, a second communication interface/circuit 2708, a memory/storage device 2724, and/or a processing circuit 2704. The first communication interface/circuit 2706 may serve to couple to a single line interrupt request (IRQ) bus to which a plurality of other devices may be coupled. In one example, the first communication interface 2706 may include the master device receiver logic 2600 (FIG. 26) that permits the master device to wake up from a sleep mode upon detection of an interrupt signal by a slave device over the IRQ bus. The second communication interface/circuit 2708 may serve to couple to the shared control data bus to which the plurality of other devices may also be coupled. The second communication interface may serve for the master device to poll the plurality of slave devices coupled to the shared control data bus and/or send commands (e.g., read and/or write operations) to the slave devices.

The processing circuit 2704 may include various sub-circuits and/or modules to carry out one or more functions described herein. For example, a communication management circuit/module 2710 may be adapted to manage communications over the shared control data bus for all devices coupled to the control data bus based on interrupt signals asserted over the separate IRQ bus. An IRQ bus monitoring circuit/module 2712 may be adapted to monitor the IRQ bus to ascertain when an IRQ signal has been asserted (e.g., by a slave device). A slave wake up circuit/module 2714 may be adapted to send a global wake up command and/or implement a targeted wake up process (e.g., global wake up followed by targeted sleep command of non-targeted devices) for devices coupled to the shared control data bus. A slave sleep circuit/module 2716 may be adapted to send a global sleep command and/or a targeted sleep command to devices coupled to the shared control data bus. A data bus monitoring circuit/module 2718 may be adapted to allow the master device to monitor the control data bus to ascertain the start and/or end of communications on the shared control data bus. A power conservation circuit/module 2720 may serve to place the master device in a sleep mode of operation. A master/slave mode circuit/module 2722 may serve to switch the master device 2702 between operating as a slave device and operating as a master device.

The memory/storage device 2724 may serve to store a slave device sleep status list that may be maintained by the master device 2702 to track which slave devices are in sleep mode and which are awake. The master device 2702 may add a slave device to the list upon indication that such slave device has gone into a sleep mode and it may remove a slave device from the list when it receives an indication that such device has awakened.

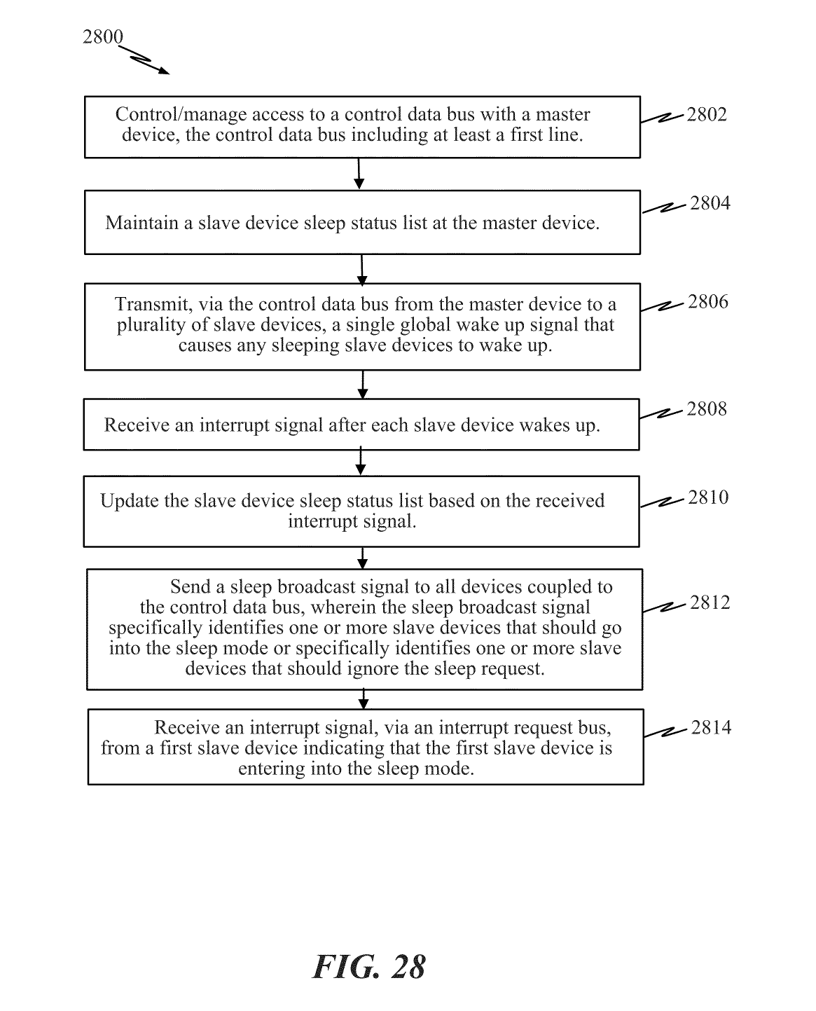

FIG. 28 illustrates an exemplary method 2800 operational at a master device to awaken from a sleep mode and/or to awake one or more sleeping slave devices. The master device may control a control data bus with the master device, the control data bus including at least a first line 2802. In one example, the control data bus may be a two-line bus and the wake up signal is implemented by bringing the first line high or low for a predetermined period of time. According to various example, the predetermined period of time may be about and/or at least 10 μseconds, 20 μseconds, 25 μseconds, 30 μseconds, 35 μseconds, or 40 μseconds. In some examples, the predetermined period of time may be between 25 μseconds and 30 μseconds, between 28 μseconds and 32 μseconds, and/or between 25 μseconds and 40 μseconds. A slave device sleep status list may be maintained at the master device 2804. The master device may transmit, via the control data bus from the master device to a plurality of slave devices, a single global wake up signal that causes any sleeping slave devices to wake up 2806. In response to the global wake up signal, the master device may receive an interrupt signal after each slave device wakes up 2808. The master device may update the slave device sleep status list based on the received interrupt signal 2810.

In an alternative implementation, the master device may implement a multi-signal targeted wake up scheme instead of a global wake up signal. Note that a targeted wake up signal is not possible through the shared control data bus since a sleeping slave device cannot be individually contacted. Instead, a two-step process is used in which a global awake up signal is first sent to awaken all devices operating on the shared control data bus. Subsequently, a targeted sleep signal is sent that selectively commands some devices (e.g., non-targeted devices not meant to be awoken) to enter into sleep mode. The targeted sleep signal may indicate which slave devices should enter sleep mode or those slave devices that should ignore the sleep signal.

According to one feature, the master device may be dynamically configurable to operate in either a master mode or slave mode, and when the master device receives a master request from a first slave device, the master device transfers the slave device sleep status list of sleeping slave devices to the first slave device before transferring control of the control data bus to the first slave device. The master device switches to operate in slave mode after transferring control of the control data bus.

In one exemplary implementation, the master device may send a sleep broadcast signal to all devices coupled to the control data bus, wherein the sleep broadcast signal specifically identifies one or more slave devices that should go into the sleep mode or specifically identifies one or more slave devices that should ignore the sleep request 2812. Subsequent to the sleep broadcast signal, the master device may receive an interrupt signal, via an interrupt request bus, from a first slave device indicating that the first slave device is entering into the sleep mode 2814.

In an alternative implementation, the master device may send a targeted sleep signal instead of a global sleep broadcast signal. The targeted sleep signal may indicate which slave devices should go into a sleep mode or those slave devices that should ignore the sleep signal.

According to another feature, the master device may enter into a sleep mode. The master device may be adapted to wake up upon receipt of a first interrupt signal from a slave device over an interrupt line separate from control data bus. For instance, the master device may include a receiver logic circuit that, if the master device is in a sleep mode, causes the master device to wake up upon detection of the first interrupt signal.

According to a slave device spontaneous wake up feature, the master device may receive an interrupt signal from an awakening slave device via an interrupt request bus separate from the control data bus. This interrupt signal may allow the master device to discover or ascertain that the slave device has spontaneously woken up and is no longer in a sleep mode. Upon receipt of the interrupt signal, the master device removes the first slave device from a slave device sleep status list.

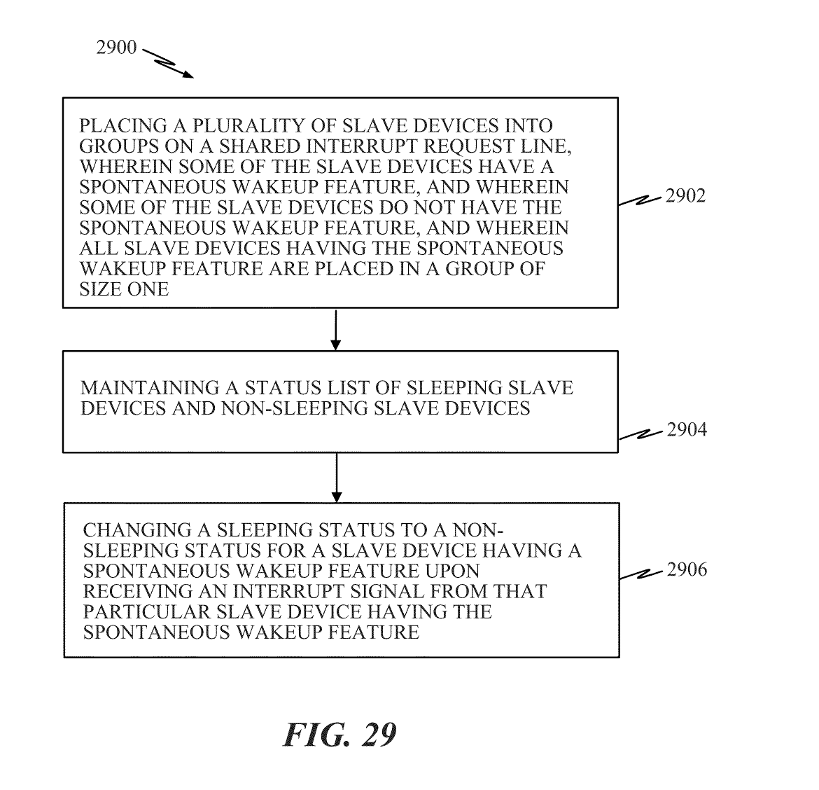

FIG. 29 illustrates an exemplary method 2900 operational at a master device for maintaining the sleep and/or awake status of slave devices. A plurality of slave devices are placed into groups on a shared interrupt request line, wherein some of the slave devices have a spontaneous wake up feature, and wherein some of the slave devices do not have the spontaneous wake up feature, and wherein all slave devices having the spontaneous wake up feature are placed in a group of size one at step 2902. The method also includes maintaining a slave device sleep status list of sleeping slave device and non-sleeping slave devices at step 2904. At step 2906, the master device changes a sleeping status to a non-sleeping status for a slave device having a spontaneous wake up feature upon receiving an interrupt signal (e.g., over an interrupt bus) from that particular slave device.

Exemplary Slave Device and Operation thereof

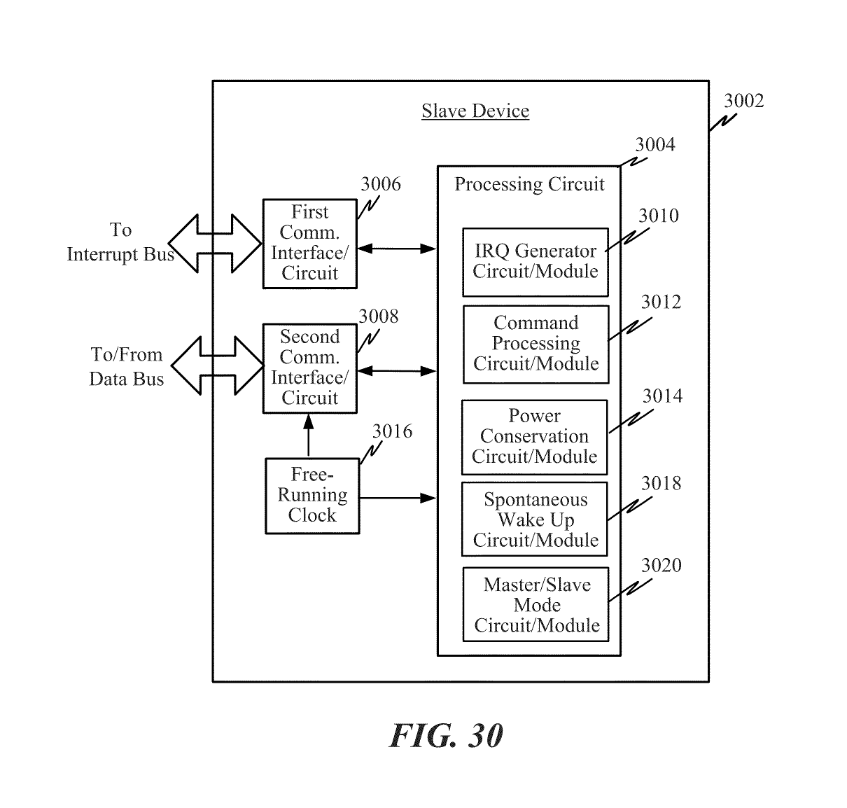

FIG. 30 is a block diagram illustrating an exemplary slave device adapted for master device-controlled wake up/sleep and spontaneous wake up on a shared bus controlled by the master device. The slave device 3002 may implement one or more features described and/or discussed with reference to FIGS. 1-26. The slave device 3002 may include a first communication interface/circuit 3006, a second communication interface/circuit 3008, a processing circuit 3004, and/or a clock 3016. The first communication interface/circuit 3006 may serve to couple to a single line interrupt request (IRQ) bus to which a plurality of other devices may be coupled. The second communication interface/circuit 3008 may serve to couple to a shared control data bus to which the plurality of other devices may also be coupled. In one example, the second communication interface 3008 may include the slave device receiver logic 1700 (FIG. 17) that permits the slave device to wake up from a sleep mode upon detection of a wake up signal by a master device over the shared control data bus. The clock 3016 may be a device providing a free-running clock signal to, for example, the second communication interface/circuit 3008 and/or the processing circuit 3004.

The processing circuit 3004 may include various sub-circuits and/or modules to carry out one or more functions described herein. For example, an interrupt (IRQ) generator circuit/module 3010 may be adapted to generate an interrupt request over the interrupt bus. A command processing circuit/module 3012 may be adapted to process commands to/from the control data bus. A mode switching circuit/module 3014 may be adapted to allow the slave device to switch between a normal mode operation and a sleep mode of operation. A power conservation circuit/module 3014 may serve to place the slave device in a sleep mode of operation. A spontaneous wake up circuit/module 3018 may serve to initiate a triggering signal or receive an external trigger signal that serves to spontaneously wake up the slave device 3002. For instance, such spontaneous wake up circuit/module 3018 may receive an external signal from a sensor, for example, via an interface other than the interrupt bus and the control data bus. A master/slave mode circuit/module 3020 may serve to switch the slave device between operating as a slave device and operating as a master device.

In one example, a receiver logic circuit may operate within the second communication interface/circuit 3008 coupled to the shared control data bus. When the slave device is in sleep mode of operation, the receiver logic circuit may be configured to: (a) obtain a free running clock signal (e.g., from the clock 3016), (b) use the free running clock signal to measure a length of time a line of the control data bus is either pulled low or high; and/or (c) wake up the slave device if the measured length of time is greater than a predetermined amount of time.

According to one aspect, in response to waking up from a sleep mode, the IRQ generator 3010 may be configured to send an interrupt signal to the master device, over a bus (i.e., IRQ bus) separate from the control data bus, indicating that the slave device has woken up. If the slave device spontaneously awakens from a sleep mode, without involvement from the master device, it may send a first interrupt signal over a shared interrupt request line. This first interrupt signal may serve to indicate to the master device that this slave device 3002 has awoken. However, the slave device may send a second interrupt signal over the shared interrupt line if there is no response to the first interrupt signal from the master device. As noted in FIG. 25, if the master device was in a sleep mode, the first interrupt signal may have served to awaken it, but the second interrupt signal allows the master device to detect that this slave device has awoken. As discussed with reference to FIG. 25, the master device takes advantage of the arbitration process on the shared interrupt request line (e.g., interrupt bus) to allow it to wake up from a sleep mode without losing track of interrupt signals from the slave devices.

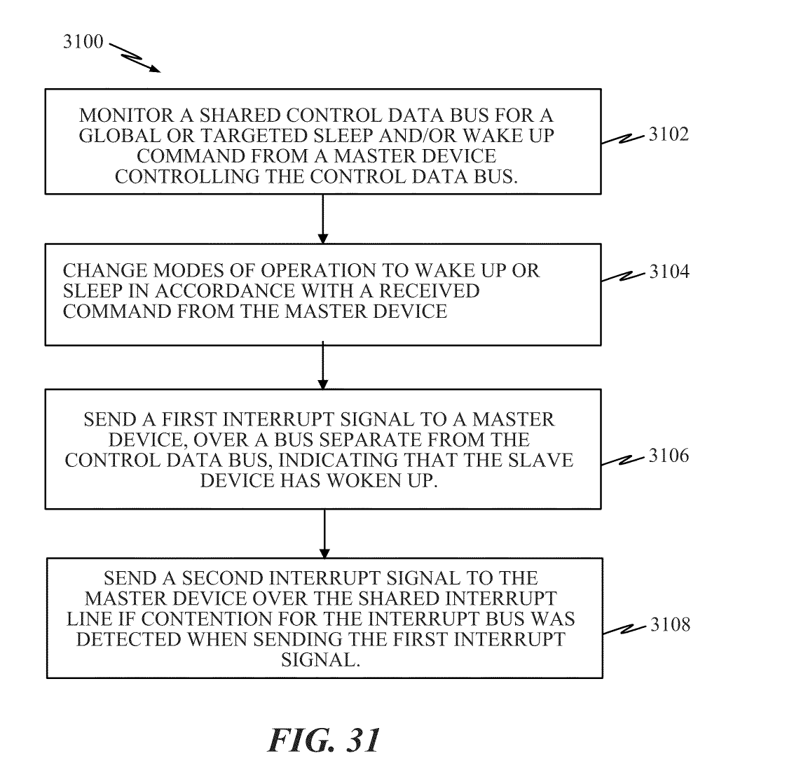

FIG. 31 illustrates an exemplary method 3100 operational at a slave device for facilitating wake up and/or sleep modes over a shared control data bus controlled by a master device. The slave device may monitor a shared control data bus for a global or targeted sleep and/or wake up command from a master device controlling the control data bus 3102. The slave device may change modes of operation to wake up or sleep in accordance with (or in response to) a received wake up or sleep command from the master device 3104. A first interrupt signal may be sent to a master device, over an interrupt bus separate from the control data bus, indicating that the slave device has woken up or is awake 3106. If the master device is awake, the master device will respond to the first interrupt signal (e.g., by sending a status request to the slave device) over the shared control data bus. However, unbeknownst to the slave device, the master device may be in a sleep mode. So, a receiver logic circuit at the master device may serve to wake up the master device upon detection of the first interrupt signal. As part of this wakeup process, the master device may pull the interrupt bus low, thereby triggering an arbitration process on the interrupt line by the slave device. That is, the slave device will notice that someone else has overwritten its interrupt on the interrupt bus/line (e.g., detects contention of the interrupt line when the first interrupt signal was sent). Consequently, the slave device may send a second interrupt signal to the master device over the shared interrupt line 3108. It is this second interrupt signal that the master device recognizes and may respond to the slave device (e.g., by polling or sending a status request to the slave device).

One or more of the components, steps, features, and/or functions illustrated in the Figures may be rearranged and/or combined into a single component, step, feature, or function or embodied in several components, steps, or functions. Additional elements, components, steps, and/or functions may also be added without departing from novel features disclosed herein. The apparatus, devices, and/or components illustrated in the Figures may be configured to perform one or more of the methods, features, or steps described in the Figures. The novel algorithms described herein may also be efficiently implemented in software and/or embedded in hardware.

In addition, it is noted that the embodiments may be described as a process that is depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. A process may correspond to a method, a function, a procedure, a subroutine, a subprogram, etc. When a process corresponds to a function, its termination corresponds to a return of the function to the calling function or the main function.

Moreover, a storage medium may represent one or more devices for storing data, including read-only memory (ROM), random access memory (RAM), magnetic disk storage mediums, optical storage mediums, flash memory devices, and/or other machine-readable mediums for storing information. The term “machine readable medium” includes, but is not limited to portable or fixed storage devices, optical storage devices, wireless channels and various other mediums capable of storing, containing, or carrying instruction(s) and/or data.

Furthermore, embodiments may be implemented by hardware, software, firmware, middleware, microcode, or any combination thereof. When implemented in software, firmware, middleware, or microcode, the program code or code segments to perform the necessary tasks may be stored in a machine-readable medium such as a storage medium or other storage(s). A processor may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

The various illustrative logical blocks, modules, circuits, elements, and/or components described in connection with the examples disclosed herein may be implemented or performed with a general purpose processor, a digital signal processor (DSP), an application specific integrated circuit (ASIC), a field programmable gate array (FPGA) or other programmable logic component, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing components, e.g., a combination of a DSP and a microprocessor, a number of microprocessors, one or more microprocessors in conjunction with a DSP core, or any other such configuration.

The methods or algorithms described in connection with the examples disclosed herein may be embodied directly in hardware, in a software module executable by a processor, or in a combination of both, in the form of processing unit, programming instructions, or other directions, and may be contained in a single device or distributed across multiple devices. A software module may reside in RAM memory, flash memory, ROM memory, EPROM memory, EEPROM memory, registers, hard disk, a removable disk, a CD-ROM, or any other form of storage medium known in the art. A storage medium may be coupled to the processor such that the processor can read information from, and write information to, the storage medium. In the alternative, the storage medium may be integral to the processor.

Those of skill in the art would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system.

The various features of the invention described herein can be implemented in different systems without departing from the invention. It should be noted that the foregoing embodiments are merely examples and are not to be construed as limiting the invention. The description of the embodiments is intended to be illustrative, and not to limit the scope of the claims. As such, the present teachings can be readily applied to other types of apparatuses and many alternatives, modifications, and variations will be apparent to those skilled in the art.

1. A device, comprising:
a control data bus including at least a first line;
a master device coupled to the control data bus and configured to manage access to the control data bus; and
a plurality of slave devices coupled to the control data bus and sharing the first line, wherein the master device is configured to send a single global wake up signal on the control data bus that causes any sleeping slave devices to wake up.

2. The device of claim 1, wherein the master device is configured to send the single global wake up signal by bringing the first line low for a predetermined period of time.

3. The device of claim 1, wherein sending the single global wake up signal comprises bringing the first line low for a predetermined period of about at least 30 μseconds.

4. The device of claim 1, wherein the master device maintains a slave device sleep status list of sleeping slave devices.

5. The device of claim 4, wherein all sleeping slave devices send a wake up confirmation signal to the master device after waking up, and the master device updates the slave device sleep status list based on the wake up confirmation signals.

6. The device of claim 4, wherein at least a first slave device is dynamically configurable to operate in either a master mode or a slave mode, and when the master device receives a master request from the first slave device, the master device transfers the slave device sleep status list of sleeping slave devices to the first slave device before transferring control of the control data bus to the first slave device.

7. The device of claim 1, wherein the master device sends a sleep broadcast signal to all devices coupled to the control data bus, wherein the sleep broadcast signal specifically identifies one or more slave devices that should go into the sleep mode or specifically identifies one or more slave devices that should ignore the sleep request.

8. The device of claim 1, wherein a first slave device coupled to the control data bus unilaterally enters into the sleep mode and notifies the master device of entering into the sleep mode via a bus separate from the control data bus.

9. The device of claim 8, wherein the master device adds the first slave device to a slave device sleep status list upon receive of the sleep notification.

10. The device of claim 1, wherein a first slave device coupled to the control data bus spontaneously wakes up, without involvement from the master device, and sends an interrupt signal to the master device, via a bus separate from the control data bus, that it has awoken.

11. The device of claim 10, wherein upon receipt of the interrupt signal, the master device removes the first slave device from a slave device sleep status list.

12. The device of claim 1, wherein the master device also includes a sleep mode, and wherein the master device is adapted to wake up upon receipt of a first interrupt signal from a slave device over an interrupt line separate from control data bus.

13. The device of claim 12, wherein the slave device sends a second interrupt signal if there is no response to the first interrupt signal from the master device.

14. (canceled)

14. A method operational on a master device, comprising:
controlling a control data bus with the master device, the control data bus including at least a first line; and
transmitting, via the control data bus from the master device to a plurality of slave devices, a single global wake up signal that causes any sleeping slave devices to wake up.

15. The method of claim 14, wherein the control data bus is a two line bus and the wake up signal is implemented by bringing the first line high or low for a predetermined period of time.

16. The method of claim 14, further comprising:
maintaining a slave device sleep status list at the master device.

17. The method of claim 16, further comprising:
receiving an interrupt signal after each slave device wakes up, and
updating the slave device sleep status list based on the received interrupt signal.

18. The method of claim 16, wherein master device is dynamically configurable to operate in either a master mode or slave mode, and when the master device receives a master request from a first slave device, the master device transfers the slave device sleep status list of sleeping slave devices to the first slave device before transferring control of the control data bus to the first slave device.

19. The method of claim 18, further comprising:
switching to operate in slave mode after transferring control of the control data bus.

20. The method of claim 14, further comprising:
sending a sleep broadcast signal to all devices coupled to the control data bus, wherein the sleep broadcast signal specifically identifies one or more slave devices that should go into the sleep mode or specifically identifies one or more slave devices that should ignore the sleep request.

21. The method of claim 14, further comprising:
receiving an interrupt signal, via an interrupt request bus, from a first slave device indicating that the first slave device is entering into the sleep mode.

22. The method of claim 14, wherein the master device receives an interrupt signal from a slave device, via an interrupt request bus separate from the control data bus, indicating that the slave device has spontaneously woken up.

23. The method of claim 22, wherein upon receipt of the interrupt signal, the master device removes the first slave device from a slave device sleep status list.

24. The method of claim 14, wherein the master device enters into a sleep mode, and the master device is adapted to wake up upon receipt of a first interrupt signal from a slave device over an interrupt line separate from control data bus.

25. The method of claim 24, wherein upon receipt of the interrupt signal, the master device removes the first slave device from a slave device sleep status list.

26. A master device, comprising:
a bus interface to couple to a control data bus shared with a plurality of slave devices; and
a processing circuit coupled to the bus interface and configured to:
manage access to the control data bus by the plurality of slave devices; and
issue a global wake up command to the plurality of slave devices over the control data bus.

27. The master device of claim 26, wherein the processing circuit is further configured to:
maintain a slave device sleep status list; and
update the slave device sleep status list upon receiving an indication of a slave device waking up.

28. The master device of claim 26, wherein the processing circuit is further configured to:
send a single global wake up signal by bringing a first line of the control data bus low for a predetermined period.

29. The master device of claim 26, further comprising:
a receiver logic circuit adapted to sense an interrupt request from a slave device over an interrupt line and awaken the master device even when the master device is in a sleep mode.

30. A slave device, comprising:
a bus interface to couple to a control data bus shared with a plurality of slave devices; and
a receiver logic circuit coupled to the bus interface and, in a sleep mode of operation, configured to:
obtain a free running clock signal;
use the free running clock signal to measure a length of time a line of the control data bus is either pulled low or high; and
wake up the slave device if the measured length of time is greater than a predetermined amount of time.
